(19) United States
(12) Patent Application Publication
(10) Pub. No.: US 2026/0346228 A1
(43) Pub. Date: Nov. 5, 2026

(54) A PROCESS OF MAKING AN ADSORBENT BODY

(71) Applicant: IMMATERIAL LTD, Cambridge (GB)

(72) Inventors: Ailsa MORRISON, Cambridge (GB); Ceren CAMUR, Cambridge (GB); Gerard BOIX I SOLER, Cambridge (GB); Robin BABU, Cambridge (GB); Naveen KUMAR, Cambridge (GB); David FAIREN-JIMENEZ, Cambridge (GB); Sam AFFLECK, Cambridge (GB); Mohamed Maher Youssef ABDELRAOUF, Cambridge (GB); Nigel Patrick SOMERVILLE ROBERTS, Cambridge (GB)

(73) Assignee: IMMATERIAL LTD, Cambridge (GB)

(21) Appl. No.: 19/486,878

(22) PCT Filed: May 24, 2024
(86) PCT No.: PCT/EP2024/064459

§ 371 Date: Nov. 21, 2025

Related U.S. Application Data
(60) Provisional application No. 63/468,635, filed on May 24, 2023.

(30) Foreign Application Priority Data
May 24, 2023 (GB) 2307801.7

(51) Int. Cl. B01J 20/22; B01D 53/04; B01D 53/047; B01J 20/26; B01J 20/28; B01J 20/30

(52) U.S. Cl. CPC B01J 20/226; B01D 53/0462; B01D 53/0476; B01J 20/26; B01J 20/28059; B01J 20/3007; B01J 20/3042; B01D 2253/202; B01D 2253/204; B01D 2257/108; B01D 2257/11; B01D 2257/504; B01D 2257/7025; B01J 2220/44

(57) ABSTRACT

A process of making an adsorbent body including: (a) contacting adsorbent material with a polymeric organic binder powder to form a precursor material; (b) contacting the precursor material with a polymeric organic binder solution to form a solvated adsorbent mixture in a first solvent; (c) removing at least some of the first solvent from the solvated adsorbent mixture in the first solvent to form an initial adsorbent body; (d) contacting the initial adsorbent body with a second solvent to form a reduced-binder adsorbent body in a second solvent; and (e) solvent-drying the reduced-binder adsorbent body to form the adsorbent body. The adsorbent body may be used in gas storage.

### FIELD OF THE INVENTION

The present invention relates to a process of making an adsorbent body, an adsorbent body(ies), compositions comprising said adsorbent body(ies), and uses for said adsorbent body(ies). The process is simple and practical at scale. The adsorbent body produced can be robust, resistant to attrition, and high performing. The adsorbent body is suitable for use in gas storage systems and processes involving the sorption, storage and desorption of gases including carbon capture, hydrogen storage and noble gas purification. The adsorbent body comprises organic framework materials, preferably metal-organic frameworks (MOFs) and covalent-organic frameworks (COFs). Most preferably, the adsorbent body comprises a metal-organic framework (MOF). The adsorbent body typically has a desirable porosity profile with high levels of micro and meso-porosity and a relatively low level of macro-porosity, providing a high density adsorbent body with a high surface area.

### BACKGROUND OF THE INVENTION

Virtually all adsorbent materials are synthesised or formed as fine powders and are not self-supporting. To be useful in industrial processes they typically need to be formed into larger bodies to avoid problems such as compaction and channelling, which reduce fluid flow and performance. These larger bodies need to be mechanically robust and attrition resistant to be industrially useful.

Many industrial processes exist to form these fine powders into larger bodies, such as tablets or extrudates, typically by the application of high pressure or use of a binder material, or both. However, these processes very often reduce the sorbent properties of the adsorbent material or result in otherwise sub-optimal products or complex and difficult processes. The application of high pressures, e.g., as often used in tabletting processes, can destroy the internal pores of the adsorbent material. This is especially relevant to more sensitive materials such as metal-organic frameworks (MOFs) and covalent-organic frameworks (COFs).

### Processing Issues and Product Properties

An example of a metal-organic framework (MOF) that is particularly susceptible to collapse of internal pores is Zr-fumarate. Another MOF that is very hard to form into tablets is Al-fumarate, believed to be due to the platelet shape of its crystals. The high pressures needed to compensate for this crystallite morphology tend to collapse the internal pores and cause a major loss of sorbent capacity. Achieving a high density and robust adsorbent body simply by application of high pressures during processing may be counterproductive if doing so causes significant collapse of the internal pores of the adsorbent material.

An alternative to tabletting is extrusion of the porous material with a binder. However, the use of a binder brings other problems. Binders can be organic, typically organic polymeric binders, or inorganic solid binders such as alumina or clays. The high levels of particulate inorganic binders such as alumina, as typically needed for strength by the mechanism of particle: particle interlocking, reduce the performance of the adsorbent body by reducing the amount of adsorbent material in the body.

Organic polymeric binders can be effective as binders. Typically, such binders are dissolved or dispersed into a solvent and contacted with the adsorbent material. However, high levels of organic polymeric binders, applied as solutions or dispersions will typically block the pores of the adsorbent material and reduce sorbent performance.

A very important practical processing issue is the amount of solvent(s) in the mix. Many organic polymeric binders have to be added as dilute solutions or dispersions due to low solubility and/or high mix viscosity. This introduces high levels of solvent into the process. Very typically the adsorbent material contains high levels of solvent from previous synthesis and/or washing steps. The extra solvent added with the binder often will make the resulting mix soft and pasty and very difficult to handle in subsequent processing steps, such as extrusion, drying, milling and combinations thereof. A soft, pasty mass may be easy to extrude at low pressures but is almost impossible to handle after extrusion without the extrudates just sticking together. A further issue is that the solvent needs to be removed by drying. The high volumetric shrinkage coming from drying of highly solvated mixes can impose internal stresses on the drying body and means that drying conditions have to be very tightly controlled to avoid the formation of dust and other fragments.

Contacting the organic polymeric binder as a powder or solid with adsorbent material and solvent reduces the amounts of additional solvent that has to be subsequently processed. However, the effectiveness of the binder when added as a powder is typically quite low as the binder only has limited opportunity to be solubilised and dispersed by the solvent present. Consequently, high levels are typically needed and robustness can be limited. The mechanical robustness of adsorbent bodies, such as their resistance to attrition and abrasion, is typically not high enough if low levels of binder are used.

The ideal adsorbent body is one that combines high sorbent properties (usually measured by BET area and N₂ sorption isotherms) and physical robustness, such as resistance to attrition. It is also industrially preferable if the adsorbent body combines high density with high surface area and good sorbent performance. High density means that a lower volume of adsorbent body is needed for a given process requirement, as compared to a low density body. This can have very significant industrial advantages such as smaller and lighter, hence cheaper, equipment. These requirements are typically mutually contradictory. High surface area adsorbent bodies are typically associated with low density.

Whether or not the internal pores of a MOF or COF in an adsorbent body have been collapsed during processing is typically indicated by the relative density of the resultant MOF or COF body.

The relative density is defined as the envelope density of the MOF or COF body divided by the crystal density of the MOF or COF. The crystal density of the MOF or COF is the theoretical density of a single MOF or COF crystal. Very many crystal densities have been calculated and are available at the Cambridge Structural Database.

Different MOFs or COFs can have different crystal densities depending on their structure. If the envelope density of an adsorbent body is greater than the crystal density (i.e., the relative density is >1), then this is likely due to the collapse of internal pores. The greater the relative density is above 1, the more the internal pores will have been collapsed and the lower the sorption capacity. Limiting high relative density is necessary to avoid inefficient internal pore collapse. However, the relative density of an adsorbent body should typically not be much less than 1 as this would be volumetrically inefficient. Very low relative densities typically indicate excessive levels of undesirable larger macro-pores.

Throughout this application, the IUPAC definitions of micropores (diameter of <2 nm), meso-pores (diameter of 2 nm-50 nm) and macropores (diameter of >50 nm) are used.

The envelope density of a body can be measured by dividing the weight of a body (in grams) by its envelope volume (in cm³). The envelope volume is defined in ASTM D3766 as “the ratio of the mass of a particle to the sum of the volumes of the solid in each piece and the voids within each piece, that is, within close-fitting imaginary envelopes completely surrounding each piece”. The envelope density of a body can be measured using techniques based on the Archimedes principle of volume displacement and described later.

The ideal adsorbent body may be one that simultaneously meets what can appear to be contradictory requirements. The adsorbent body should be robust and attrition resistant. It should have a high surface area to have a good sorption capability. The adsorbent body ideally needs to have a high relative and envelope density so as to minimise the volume of material required for a given process. These requirements can often seem incompatible. For example, high levels of particulate binders (such as aluminas and clays), often required for robustness, reduce sorption capacity of an adsorbent body by reducing the amount of sorbent material present in the body. High levels of binders applied as solutions or liquids can block the pores of an adsorbent material, such as a MOF, and thus reduce performance. However, the mechanical robustness of adsorbent bodies is typically not high enough if low levels of binder are used, especially for more demanding applications.

Finally—and crucially—it must be possible to make the body at scale. Much of the art describes lab-based processes which have been developed using small-scale equipment. Such lab processes have little relevance for large-scale production when handling issues and requirements become much more important.

The present invention addresses, at least to an extent, these and other problems with the prior art. The present invention enables the practical production of adsorbent bodies that have desirable properties.

### SUMMARY OF THE INVENTION

Thus, in a first aspect, the present invention provides a process of making an adsorbent body, wherein the process comprises the steps of:
(1) contacting adsorbent material, optionally third solvent, and polymeric organic binder to form a solvated adsorbent mixture, wherein the adsorbent material is selected from metal-organic frameworks or precursors thereof, covalent-organic frameworks or precursors and any combination thereof and wherein polymeric organic polymeric binder is added both as a solid and as a solution/dispersion in a first solvent and wherein polymeric organic binder is adsorbed onto the surface of the adsorbent material and wherein the first solvent (and optional third solvent) is distributed throughout the solvated adsorbent mixture;
(2) forming the solvated adsorbent mixture into an initial adsorbent body by any suitable process steps including drying and milling, or extrusion and drying, or drying and extrusion and further drying; and any combinations thereof;
(3) optionally contacting the initial adsorbent body with a second solvent to form a reduced-binder adsorbent body, wherein during step (3) at least part of the organic polymeric binder is removed from the initial adsorbent body and is dissolved into the second solvent, wherein the reduced-binder adsorbent body comprises adsorbent material, polymeric organic binder, second solvent, any residual first solvent, and optionally any residual third solvent, wherein polymeric organic binder is adsorbed onto the surface of the adsorbent material and wherein the second solvent is distributed throughout the reduced-binder adsorbent body; and
(4) solvent-drying the reduced-binder adsorbent body to form the adsorbent body.

Preferably, wherein the solubility of the polymeric organic binder in the first solvent is the same or higher than the solubility of the polymeric organic binder in the second solvent.

Preferably, the adsorbent material is provided for step (1) in a third solvent as a suspension, wet cake, slurry or sludge.

For the avoidance of doubt, the first solvent, second solvent and third solvent are not necessarily all used in the process of the invention. For example, use of the third solvent does not imply use of the second solvent, i.e. the third solvent may be used in the claimed process without the use of the second solvent.

In a second aspect, the invention also provides an adsorbent body(ies), particularly those made by the inventive process. In a third aspect, the invention further provides the use of such an adsorbent body(ies) in adsorption-based processes (e.g. gas storage, particularly carbon dioxide or hydrogen storage). The adsorbent bodies can be in any suitable form as described herein and are especially suitable for use in a wide range of vessels used in gas storage and processing applications. One preferred form of adsorbent bodies are extrudates or other shaped bodies. Another preferred form are adsorbent bodies which have been milled and sieved so as to provide bodies having a range of particle sizes. The particle size may be less than about 2 mm, which may result in high density and high packing efficiency. The bodies can be added to storage vessels or can also be incorporated into films, sheets or membranes or in other forms of structured packing.

In a fourth aspect, the invention provides a composition comprising an adsorbent body or one or more, or a plurality of, adsorbent bodies produced by the process of the first aspect. The composition may comprise an additive.

In a fifth aspect, the invention provides a gas storage vessel comprising the composition as defined herein.

In a sixth aspect, the invention provides the use of a gas storage vessel as defined herein or a composition as defined herein for the uptake, storage and/or release of a gas.

During optional step (3) at least part of the organic polymeric binder is removed. For example, the amount removed could be more than about 2%, more than about 4%, more than about 5% or more than about 10% or more than about 15% of the organic polymeric binder originally added (as measured by the relative proportion of binder to adsorbent material described herein). It is preferable to remove the least amount necessary to achieve good surface areas as this simplifies processing. The amount removed could be less than about 20% of the organic polymeric binder originally added. The amount of polymeric organic binder removed may be from about 2% to about 20%, or from about 4% to about 15%, or from about 5% to about 10% of the polymeric organic binder originally added.

The organic polymeric binder added in Step 1 may be one material or multiple materials. For example, one type of organic polymeric binder could be added as a powder and another organic polymeric binder could be added as a solution or dispersion in a solvent.

The terms “organic polymeric binder” or “polymeric organic binder” are used interchangeably herein. These terms refer to all organic polymeric binder material unless specified otherwise.

### DETAILED DESCRIPTION OF THE INVENTION

### Process of Making an Adsorbent Body

The process of making an adsorbent body is further explained by these more detailed steps wherein Step (1) above further comprises steps (a) and (b), Step (2) comprises step (c), optional Step (3) comprises step (d), and Step (4) comprises step (e). The process comprises the steps of:
(a) contacting adsorbent material, and optionally third solvent, with a polymeric organic binder powder to form a precursor material, wherein the adsorbent material is selected from metal-organic frameworks or precursors thereof, covalent-organic frameworks or precursors thereof, and any combination thereof, wherein the polymeric organic binder powder comprises a first polymeric organic binder, and wherein the precursor material comprises adsorbent material and first polymeric organic binder;
(b) contacting the precursor material with a polymeric organic binder solution to form a solvated adsorbent mixture in a first solvent (and optional third solvent), wherein the polymeric organic binder solution comprises a second polymeric organic binder and a first solvent, wherein the solvated adsorbent mixture comprises adsorbent material, first polymeric organic binder, second polymeric organic binder and first solvent (and optional third solvent), wherein first polymeric organic binder and second polymeric organic binder are adsorbed onto the surface of the adsorbent material and wherein the first solvent (and optional third solvent) is distributed throughout the solvated adsorbent mixture;
(c) subjecting the solvated adsorbent mixture to a body forming process, wherein the process comprises:
   (i) at least one process step selected from the group consisting of spreading, extrusion, cutting, milling, sieving, molding, granulation, pressing and tabletting; and
   (ii) a solvent drying step comprising removing at least some of the first solvent (and optional third solvent) from the solvated adsorbent mixture to form an initial adsorbent body;
(d) optionally contacting the initial adsorbent body with a second solvent to form a reduced-binder adsorbent body, wherein during step (d) part of the combined weight of the first and second polymeric organic binder initially present is removed from the initial adsorbent body and is dissolved into the second solvent, wherein the reduced-binder adsorbent body comprises adsorbent material, first polymeric organic binder, second polymeric organic binder, second solvent and residual first solvent (and residual optional third solvent), wherein the first polymeric organic binder and the second polymeric organic binder are adsorbed onto the surface of the adsorbent material and wherein second solvent is distributed throughout the reduced-binder adsorbent body; and
(e) solvent-drying, e.g. the initial adsorbent body or optionally the reduced-binder adsorbent body, to form the adsorbent body.

The time interval between steps (a) and (b) may be varied depending on the needs of the process. For example, the properties of some adsorbent materials and/or binders may benefit from a shorter time interval between steps (a) and (b) than other adsorbent materials and/or binders, and vice versa. For example, the time interval between step (a) and step (b) may be from about 1 minute to about 180 minutes, preferably from about 5 minutes to about 120 minutes, preferably from about 10 minutes to about 90 minutes, preferably from about 30 minutes to about 60 minutes. Steps (a) and (b) may overlap, for example the addition of polymeric organic binder solution may begin before the addition of polymeric organic binder powder is complete.

Preferably, the adsorbent material in step (a) is provided in a third solvent, for example as a gel, slurry, sludge or wet cake. For instance, the adsorbent material is first combined with a third solvent prior to step (a), i.e. the adsorbent material in step (a) is provided with the third solvent as e.g. a gel, slurry, sludge or wet cake. Alternatively or additionally, the adsorbent material may be provided as a solid, e.g. as a particulate.

Preferably step (a) precedes step (b) as it is believed to be more effective for polymeric organic binder powder to be first contacted with the adsorbent material (and optionally the third solvent) as this increases the ability of the solvent to solubilise the powder binder.

However, steps (a) and (b) may happen simultaneously or the binder solution in step (b) be contacted first with the adsorbent material and optionally the third solvent. The adsorbent material is typically present as a slurry or sludge material also containing third solvent from previous adsorbent material synthesis and/or process step(s) such as washing. Synthetic processes can include sol-gel processes or mechanosynthesis processes and other low solvent synthesis routes. Alternatively, the adsorbent material could be a pre-formed powder.

Preferably the solubility of the first polymeric organic binder and the second polymeric organic binder in the first solvent is the same or higher than the solubility of the first polymeric organic binder and the second polymeric organic binder in the second solvent.

Preferably the solubility of the first polymeric organic binder and the second polymeric organic binder in the third solvent is the same or higher than the solubility of the first polymeric organic binder and the second polymeric organic binder in the second solvent.

It may be preferred for the first polymeric organic binder and the second polymeric organic binder to be independently selected from polyvinyl alcohol (PVA), polyvinyl acetate, polyvinyl alcohol/acetate copolymers, polyimide, polyamide, polyolefin, polyvinyl pyrrolidone, polyacrylates include polyacrylic acid or sodium polyacrylate, polycarboxylates, polyethylene glycols, polypropylene glycol, poly(1,4-phenylene-ether-ether-sulfone) (PFEES), poly(dimethylsiloxane) (PDMS), poly(tetrahydrofuran) (PTHF), polylactic acid and derivatives thereof or a biopolymer-based material such as polysaccharide gums including xantham gum, guar gum, alginate, chitosan, cellulose-based polymers such as cellulose, cellulose acetate, hydroxypropyl methyl cellulose (HPMC), methyl cellulose, ethyl cellulose, hydroxyethyl cellulose, hydroxypropyl methylcellulose phthalate (HPMCP), or any mixtures and combinations thereof. Preferably, the first and second polymeric organic binder are independently selected from polyvinyl alcohol (PVA), polyvinyl acetate, polyvinyl alcohol/acetate copolymers, polyimide, polyamide, polyvinyl pyrrolidone, polyacrylates include polyacrylic acid, polycarboxylates, polyethylene glycols, poly(1,4-phenylene-ether-ether-sulfone) (PFEES), poly(tetrahydrofuran) (PTHF), polylactic acid and derivatives thereof or a biopolymer-based material such as polysaccharide gums including xantham gum, guar gum, alginate, chitosan, cellulose-based polymers such as cellulose, cellulose acetate, hydroxypropyl methyl cellulose (HPMC), methyl cellulose, ethyl cellulose, hydroxyethyl cellulose, hydroxypropyl methylcellulose phthalate (HPMCP), or any mixtures and combinations thereof. It may be preferred for the first polymeric organic binder and the second polymeric organic binder to be more hydrophobic.

It may be preferred in some embodiments if the first and second polymeric organic binder(s) are soluble in water and aqueous mixtures of solvents or just in a non-aqueous solvent. It may be preferred in some embodiments to use binders that are more hydrophobic in nature and hence typically not highly soluble, or even insoluble, in water.

Preferably, the first organic polymeric binder can be a mixture of binders. Preferably, the second organic polymeric binder can be a mixture of binders. In each case the mixture of binders may be selected from the polymeric organic binders disclosed herein. The first organic polymeric binder mixture and the second organic polymeric binder may be the same or may be different.

It may be preferred for the organic polymeric binder to be further modified, such as by a silanisation step, after formation of the adsorbent body.

### Step (a) Forming a Precursor Material

Step (a) contacts adsorbent material (and optionally a third solvent) with an organic polymeric binder powder to form a precursor material. The adsorbent material may be contacted with the polymeric organic binder powder by shear mixing, tumbling mixing or convective mixing, for example.

The adsorbent material is selected from metal-organic frameworks or precursors thereof, covalent-organic frameworks or precursors thereof, and any combinations thereof. The adsorbent material is described in more detail herein.

The adsorbent material in step (a) may be provided in a third solvent, for example as a gel, slurry, sludge or wet cake.

The adsorbent material may be in particulate form or the adsorbent material may be dispersed in a wet cake, gel, sludge or slurry in a third solvent. Preferably, the adsorbent material is in the form of a slurry or sludge with solvent, preferably an aqueous slurry or sludge. The term slurry refers to a heterogenous mixture of solid particles suspended in a liquid. Typically a slurry has a higher solid concentration as compared to a suspension. The term sludge refers to a heterogenous mixture of solid particles suspended in a liquid having a higher solid concentration than a slurry, e.g. a concentrated slurry.

The adsorbent material slurry may be prepared by reacting adsorbent material precursors to form the adsorbent material prior to contacting the adsorbent material with polymeric organic binder powder. The reaction of the adsorbent material precursors to form the adsorbent material may be carried out under aqueous conditions to produce the adsorbent material in the form of a slurry. The slurry may then concentrated, e.g., by centrifugation, to reduce the water content of the slurry to form a concentrated slurry or wet cake. The adsorbent material in the form of a concentrated slurry (sometimes referred to as a “sludge”) may then be contacted with the polymeric organic binder powder in step (a). The addition of polymeric organic binder powder at this stage can most effectively thicken the slurry as the third solvent solvates the organic polymeric binder powder and the organic polymeric binder powder may be solubilised and dispersed, thus acting as a binder and producing a concentrated slurry. Thickening the adsorbent material slurry or paste is advantageous because it simplifies subsequent processing and production of the adsorbent body.

The polymeric organic binder powder comprises a first polymeric organic binder. The first polymeric organic binder is in the form of a powder. The first polymeric organic binder may be selected from the list of organic polymeric binder materials described herein.

The polymeric organic binder powder may have a mean particle size of from about 0.1 μ(or μm) to about 400 μ, or from about 10 μto about 250 μ, measured as described herein.

The polymeric organic binder powder may have a water content of less than about 10 wt %, less than about 5 wt %, or less than about 1 wt % by weight of the powder.

The precursor material comprises adsorbent material and first polymeric organic binder (and optionally third solvent). The ratio of adsorbent material to first polymeric organic binder in the precursor material may be from about 2:1 to about 20:1, or from about 5:1 to about 15:1, or from about 7:1 to about 10:1.

The precursor material may be in particulate form or may be in the form of a paste, gel or a slurry/sludge. Preferably, the precursor material is in the form of a paste or slurry/sludge.

### Step (b) Forming a Solvated Adsorbent Mixture

Step (b) contacts the precursor material with polymeric organic binder solution to form a solvated adsorbent mixture in a first solvent (and optional third solvent).

The adsorbent material is described in more detail below.

The polymeric organic binder solution comprises a second polymeric organic binder and a first solvent. The first solvent may comprise a single solvent or may comprise a mixture of more than one solvents.

The polymeric organic binder solution may be a true solution, i.e. the second polymeric organic binder is fully dissolved in the first solvent, or a colloidal solution.

The second polymeric organic binder may be the same as the first polymeric organic binder. Alternatively, the second polymeric organic binder may be different to the first polymeric organic binder.

The second polymeric organic binder may be selected from the list provided for the first polymeric organic binder described herein. Preferably, the second polymeric organic binder may be selected from the group consisting of: polyvinyl alcohol (PVA), polyvinyl acetate, polyvinyl alcohol/acetate copolymers, polyimide, polyamide, polyvinyl pyrrolidone, polyacrylates include polyacrylic acid, polycarboxylates, polyethylene glycols, poly(1,4-phenylene- ether-ether-sulfone) (PFEES), poly(tetrahydrofuran) (PTHF), polylactic acid and derivatives thereof or a biopolymer-based material such as polysaccharide gums including xantham gum, guar gum, alginate, chitosan, cellulose-based polymers such as cellulose, cellulose acetate, hydroxypropyl methyl cellulose (HPMC), methyl cellulose, ethyl cellulose, hydroxyethyl cellulose, hydroxypropyl methylcellulose phthalate (HPMCP), or any mixtures and combinations thereof.

The solvated adsorbent mixture comprises adsorbent material, first polymeric organic binder, second polymeric organic binder and first solvent (and optional third solvent).

During step (b), the first and second polymeric organic binder are adsorbed onto the surface of the adsorbent material.

During step (b), the first solvent (and optionally third solvent) is distributed throughout the solvated adsorbent mixture.

During step (b), a portion of the first solvent (and optionally third solvent) may provide a continuous liquid medium and/or a dispersing medium. Herein, the adsorbent material with first and second polymeric organic binder adsorbed thereon may provide the dispersed phase.

The first solvent may comprise “free” first solvent. The third solvent may comprise “free” third solvent. For the purposes of the invention, “free” solvent refers to solvent (first, second or third) which is external to particles or bodies of adsorbent material. Free solvent is not adsorbed into or held in the internal pores of the adsorbent material and typically can be at least partially removed by processes such as centrifugation and decanting or by filtration.

Step (b) may comprise one or more processing steps. Suitable processing steps include: (i) a concentration step, e.g., by filtration, sedimentation and/or centrifugation, in which at least some first solvent (and optionally third solvent), e.g. free solvent, is removed from a more dilute mix of the adsorbent material in the first solvent (and optionally third solvent); (ii) a mixing step; (iii) an extrusion step; (iv) and any combination thereof.

During step (b) the adsorbent material may be collected as a mixture, filtrate or precipitate either before or after contact with the polymeric organic binder solution. The adsorbent material may be extruded, spread out to form a thin layer, tabletted and/or otherwise formed into a body. Typically, the adsorbent material is extruded after being collected as a filtrate or precipitate. During step (b), it might be preferred for the adsorbent material to be extruded and subjected to a rounding step such as spheronisation. Suitable extrusion equipment includes single or twin-screw extruders, optionally with a die-face cutter, and a spheroniser. Suitable equipment is supplied by Caleva Ltd. Step (b) may also include other body-forming processes.

The combination of step (a) and step (b), i.e. adding a portion of polymeric organic binder as a powder and then a portion of polymeric organic binder as a solution reduces the total amount of solvent in the process whilst still providing good robustness and surface area. It consequently simplifies the rest of the processing steps.

Step (a) and step (b) may also include addition of other powder materials apart from the organic polymeric binder powder to the adsorbent material. These additional powders may be useful for changing the rheological properties of the slurry or sludge. Possible additional powders include inert adsorbent powders such as silica or even pre-dried adsorbent material.

### Step (c) Forming an Initial Adsorbent Body

Step (c) removes at least some of the first solvent (and optional third solvent) from the solvated adsorbent mixture in the first solvent (and optional third solvent) to form an initial adsorbent body. Typically, step (c) includes removal of free first solvent (and optionally free third solvent), preferably substantially all thereof. Typically, the removal of first solvent (and optionally third solvent) in step (c) is accompanied by a hardening of the initial adsorbent body as the first solvent (and optionally third solvent) can act as a plasticiser and lubricant, thus softening the initial adsorbent body. The initial adsorbent body can also be hardened during step (c) by the addition of an adsorbent powder as described above to the solvated adsorbent mixture. This can simplify processing. The initial adsorbent body needs to be robust enough for subsequent process steps.

Step (c) can also include additional process steps, such as milling or otherwise breaking up initial adsorbent bodies prior to subsequent steps, e.g. step (d) and/or step (e).

Step (c) can be selected from:
(i) a low temperature solvent drying step wherein the drying step is carried out at a temperature of less than about 50 °C, preferably less than about 35 °C, for a period of time of longer than about 5 hours, and at pressure of from about 0.5 to about 1.0 bar (50 to 100 kPa), and wherein the first solvent has a boiling point of about 120 °C or less;
(ii) a supercritical drying step;
(iii) a freeze-drying step;
(iv) drying at a temperature of from greater than about 50 °C to less than about 200 °C, and wherein the first solvent has a boiling point of greater than about 120 °C; and
(v) drying at temperatures of greater than about 50 °C and wherein the gaseous concentration of the first solvent being removed in the head space above the solvated adsorbent mixture is maintained at between about 60% and about 95% of its saturation value at the given drying temperature for at least about 1 hour.

Step (c) can comprise a centrifugation and/or filtration step followed by a solvent-drying step. Step (c) can also comprise only a solvent-drying step.

Typically, step (c) is carried out under mild conditions. Conditions of step (c) can depend on the type of first solvent (and optional third solvent) used. First solvents that have low-volatility can be dried at higher temperatures than first solvents that have high-volatility. During drying, the force of the surface tension of the drying liquid pulling on the solids it is in contact with is preferably minimized. Rapid drying is undesirable and may impact the tight, coherent packing of the adsorbent material when forming the adsorbent body. Reducing the rate of drying during step (c) is preferred.

Step (c) can use any suitable heat source, including microwave drying.

Step (c) can also include a size reduction step to reduce the size of the initial adsorbent bodies prior to subsequent steps, e.g. step (d) and/or step (e). Such a size reduction step, for example using a cutting mill, can produce smaller initial adsorbent bodies, such as bodies having a diameter of less than about 2 mm or even less than about 1 mm. This can accelerate step (d) and also produce adsorbent bodies having sizes and size distributions suitable for use in gas sorption, desorption and storage processes.

### Optional Step (d) Forming a Reduced-Binder Adsorbent Body

Step (d) optionally contacts the initial adsorbent body with a second solvent to form a reduced-binder adsorbent body and second solvent. Typically, the second solvent comprises free solvent, e.g., a second free solvent.

Herein, the second free solvent is second solvent that is surrounding the initial adsorbent bodies. Typically, dissolved first and second polymeric organic binder material will diffuse out from the initial adsorbent bodies into the second solvent (second free solvent). It is preferable if the solubility of the first and second polymeric organic binder is lower in the second solvent than in the first solvent (and optional third solvent).

During step (d), part of the organic polymeric binder is removed from the initial adsorbent body and is dissolved into the second solvent. Typically, the amount of first and second polymeric organic binder removed may be assessed using thermogravimetric analysis as described herein.

Without wishing to be bound by theory, it is believed that contacting the initial adsorbent body with second solvent during step (d) preferentially removes the first and second organic polymeric binder that is initially most accessible to the solvent. This is believed to be first and second polymeric organic binder that is likely to be least involved in binding the adsorbent material together and most likely to block the pores of the adsorbent material The inventors believe that the first and second polymeric organic binder that is in closest contact with the adsorbent material will be the slowest to dissolve because it is the least accessible. The first and second polymeric organic binder that is left is believed to be the most effective at binding adsorbent material particles together. In this manner, step (d) removes the first and second polymeric organic binder that is most likely blocking any pores of the initial adsorbent body.

During step (d) the second solvent is distributed throughout the reduced-binder adsorbent body.

Preferably, during step (d) the initial adsorbent body is in contact with the second solvent for a period of time of greater than about five (5) hours, or longer than about 10 hours, or longer than about 20 hours, or longer than about 25 hours, or longer than about 30 hours, or longer than about 50 hours or even longer than about 96 hours. The second solvent may be contacted with the initial adsorbent body in a variety of ways, e.g. by suspending the initial adsorbent body in the second solvent.

Step (d) may also remove any residual reactants (e.g. adsorbent material and/or adsorbent material precursors) or residual first solvent (and optionally residual third solvent) from the initial adsorbent body. Step (d) may happen in multiple ways—for example in several steps with smaller amounts of second solvent being replaced periodically rather than a larger volume of second solvent being used in one step. This can have advantages in limiting macroporosity by controlling the rate at which polymeric binder is removed from the initial adsorbent body. In step (d), despite best efforts and due to potential limitations of solvent washing, residual solvent (first solvent) may still remain in the reduced-binder adsorbent body after the solvent washing step.

The solubility of the first and second polymeric organic binder in the second solvent does not need to be high during step (d). The objective of step (d) is not to remove all of the polymeric organic binder from the initial adsorbent body.

It is advantageous to remove a portion of polymeric organic binder to achieve desirable adsorbent body properties. However, binder reduction step (d) is not essential for all adsorbent materials. For example, UTSA-16, MOF-808 and ZU-301 do not require a binder removal step to achieve adsorbent bodies having desirable properties.

### Step (e) Forming the Adsorbent Body

Step (e) is a solvent drying step to form the adsorbent body. Step (e) may be carried out on the initial adsorbent body and/or the reduced-binder adsorbent body. This can happen over one or more process steps and typically involves a higher temperature (e.g. >100 °C) so as to remove residual solvent from within the internal pores of the adsorbent material. This is referred to as activation and is very commonly done to adsorbent bodies prior to use.

The solvent-drying may be carried out by evaporation, wherein the solvent is heated above its boiling point. Alternatively, the solvent-drying may be carried out by freeze-drying (or lyophilisation).

### Adsorbent Body

The adsorbent body comprises adsorbent material, first polymeric organic binder and second polymeric organic binder.

Typically, the weight ratio of adsorbent material to first and second polymeric organic binder present in the adsorbent body is from 1:1 to 25:1, or from 2:1 to 20:1, or even from 4:1 to 15:1. That is, the weight ratio of adsorbent material to the total combined weight of first polymeric organic binder and second polymeric organic binder present in the adsorbent body is from 1:1 to 25:1, or from 2:1 to 20:1, or even from 4:1 to 15:1. Typically, the weight ratio of adsorbent material to the first and second polymeric organic binder (total combined weight of first polymeric organic binder and second polymeric organic binder) present in the adsorbent body may greater than 3:1. It may be preferred that the weight ratio of adsorbent material to first and second polymeric organic binder present in the adsorbent body is greater than 5:1. These levels of organic polymeric binder are sufficient to give the inventive adsorbent bodies good mechanical robustness.

The adsorbent body may comprise a material selected from:
(a) nanoparticles of metals and metal salts;
(b) enzymes;
(c) magnetic materials;
(d) dyes and pigments;
(e) graphene; and
(f) any combination thereof.

Suitable nanoparticles include metal and metal oxide nanoparticles selected from Pd, Au, Ru, Rh, Pt, Fe, Sn, Zn, Ti, Pd and any combination thereof. The nanoparticles can be photoactive, such as being photo-catalytically active. Photoactive nanoparticles can include perovskites, especially halogen perovskites. Nanoparticles can be embedded in the adsorbent body where they can help bind adsorbent particles together or can be trapped within particles of adsorbent material. If any nanoparticles are present, then their level in the adsorbent body is usually less than about 0.15% volume of the adsorbent body. Suitable nanoparticles typically have a weight average particle size of less than about 200 nm.

These additional materials are typically added prior to step (e) and are typically added during step (b). Materials such as nanoparticles are preferably incorporated into the adsorbent material particles during the synthesis of the adsorbent material.

The adsorbent bodies can be subjected to a size reduction step to reduce the size of the adsorbent bodies prior to use. Such a size reduction step, for example using a cutting mill, can produce smaller adsorbent bodies, such as bodies having a diameter of less than about 2 mm or even less than about 1 mm. The adsorbent bodies can be in the form of extrudates or pellets. A preferred form for the adsorbent bodies is a blend of particles of differing particle sizes to ensure good particle pacing in a gas storage vessel. Another preferred form of adsorbent body comprises extrudates having an aspect ratio (the ratio of the longest dimension of the body to the shortest dimension of the body) of greater than about 2 or greater than about 3. Such extrudates can be more easily processed and have a high packing efficiency when combined with a second population of adsorbent bodies having a largest particle dimension about equal to or less than the thickness of the extrudates.

### MOF and COF Organic Framework Adsorbent Bodies Made of Adsorbent Material

Adsorbent bodies made by the above process preferably comprise:
(a) at least about 50 wt % MOF or COF particles; and
(b) from about 2.0 wt % to about 25 wt %, preferably from about 3 wt % to about 20wt% or from about 5 wt % to about 15 wt %, organic polymeric binder, wherein the organic polymeric binder comprises first polymeric organic binder and second polymeric organic binder,
   wherein the adsorbent body has:
(i) an envelope density of greater than about 0.5 g/cm³;
(ii) a relative density of from greater than about 0.4 to less than about 1.2;
(iii) a BET area by N₂ adsorption of greater than about 10 m²/g, preferably greater than about 100 m²/g, preferably greater than 300 m²/g, preferably greater than 500 m²/g;
(iv) a micro-porosity of greater than about 40% of the total pore volume as measured by N₂ adsorption; and
(v) a macro-porosity of less than about 15%, preferably less than about 10%, preferably less than 7% as measured by mercury intrusion porosimetry.

The adsorbent body can have a BET area of greater than about 10 m²/g, or greater than about 100 m²/g, or greater than about 300 m²/g, or greater than about 400 m²/g or greater than about 700 m²/g to about 1000 m²/g or to about 1500 m²/g.

### Adsorbent Material

The adsorbent material is selected from metal-organic frameworks (MOFs) or precursors thereof, covalent-organic frameworks (COFs) or precursors thereof, or any combination thereof. The adsorbent material may be selected from metal-organic frameworks (MOFs), covalent-organic frameworks (COFs), or any combination thereof. Most preferably, the adsorbent material is a metal organic framework (MOF). The adsorbent material can be a combination of two or more metal organic frameworks (MOFs).

Preferably, the adsorbent material is in particulate form. The adsorbent material can be dispersed in a gel or slurry. More preferably, the adsorbent material is in particulate form having a mean particle size of less than about 900 nm. Preferably, the SAXS particle size distribution of the adsorbent particulate material is mono-modal. However, the SAXS particle size distribution of the adsorbent particulate material may be bi-modal. By mono-modal, it is typically meant that the sizes of the adsorbent material comprise one distribution having one peak. By ensuing that the adsorbent material has a mono-modal particle size distribution, the adsorbent materials are believed to be able to pack more closely together and enables the formation of an adsorbent body having a high density.

Preferably, the adsorbent material is in the form of crystallites.

Preferably, the adsorbent material has a small particle size, preferably having a weight average particle size of from about 5 nm to about 900 nm, or from about 10 nm to about 800 nm, or from about 12 nm to about 700 nm, or from about 15 nm to about 500 nm. The method of measuring particle size is described in more detail below. The particle size of the adsorbent material is preferably measured once the material has been formed into the adsorbent body using XRD techniques as described later. However, the particle size of the adsorbent material can also be measured prior to step (a) when in the form of a slurry. Dynamic Light Scattering techniques for measuring particle size need to be used in this case.

In case of inconsistent results, XRD testing of the adsorbent body is most applicable.

The particle size control of the adsorbent material is believed to be important to ensure the formation of a high-quality coherent adsorbent body. If the particles are too large, then this can lead to the formation of an adsorbent body having a poor (low) density profile and/or a poor robustness.

### MOFs

Metal-organic frameworks (referred to as MOFs) are a relatively new class of sorbent materials that can be used to adsorb, store and desorb gases. MOFs can offer many performance advantages over older sorbent materials (such as zeolites and activated carbons) and are candidates for improved gas storage systems required for practical transport systems as well as applications such as gas separation, purification and carbon capture. A particular feature of MOFs is their high selectivity for specific species. Specific MOFs can be modified by changing organic linkers and metal ions and fine-tuning the properties to increase their selectivity in adsorbing specific species.

MOFs have been investigated for various gas storage and purification applications, such as carbon capture from air and flue gases, methane storage, hydrogen storage, gas separation and purification and noble gas purification. MOFs are often ideally suited for these applications since they typically possess high porosity, surface area and selectivity and can also be regenerated for continuous use, thereby providing an effective and environmentally friendly means for gas storage and purification applications. However, problems relating to handling have often limited their industrial application to date.

Suitable MOFs may vary depending on the gas storage or purification application and the type of gas or adsorbing species that are involved. For example, for a carbon capture application, it may be preferable to select a MOF with a high uptake and selectivity towards carbon dioxide. In some embodiments, the MOF is selected from one or more of the following HKUST-1, ZIF-8, MOF-808, ZU-301, UTSA-16, CALF-20, CALF-15, TIFSIX-3-Ni, NbOFFIVE-1-Ni, MOF-74/CPO-27, SIFSIX, UiO-66 esp UiO-66-NH₂, UiO-67, UiO-68, NU-1000, PCN-222, Al or Zr Fumarate, Al Formate or mixtures thereof.

Typically the MOFs can include (i) Zr-containing MOFs, (ii) Zn-containing MOFs such as Zeolite Imidazolate Frameworks and Zn-containing UTSA-16, CALF-15, CALF-20 and ZnNi(NA); (iii) MOF-74 and derivatives thereof; (iv) Al-based MOFs; (v) Fe-based MOFs; (vi) MOFs of the M(F₆₋ₓ)Lₓ family; (vii) Cu-based MOFs; (viii) Co-based MOFs; (ix) Cr-based MOFs; (x) Nb-based MOFs such as NbOFFIVE; (xi) Ni-based MOFs; (xii) Mn-based MOFs; (xiii) mixed metal MOFs; and (xiv) combinations thereof.

The MOF may be selected based on the environment and conditions to which the MOF monolithic body (adsorbent body) is subjected, and the stability of the MOF, such as the thermal, chemical and/or mechanical stability of the MOF. For example, in gas purification and/or storage applications involving high temperatures and/or the presence of moisture, it may be preferable that a MOF with high thermal and chemical stability is selected. For example, for carbon capture from flue gas, the gas stream may contain water, and therefore it may be preferable to select a MOF with a high stability towards water.

It is important that the MOF retains its porosity during processing. MOFs are often not very robust due to the nature of the ligand-metal ion bonds forming the pore structures. These bonds depend on metal co-ordination chemistry rather than being stronger covalent or ionic bonds. It is possible to deform and crush the MOF pores by application of external pressure and hence reduce the surface area of the MOF that is available for gas sorption. Different MOFs have different stabilities and strengths, which the skilled person will be aware of. MOF stabilities and strengths typically depend on properties such as the MOF composition and crystal structure.

For the purpose of clarity, references to a MOF include derivatives of that MOF including derivatives of the organic linkers and changes to the metal ions and/or clusters used as well as combinations and mixtures thereof. For example, references to CPO-27 may include CPO-27-Ni, CPO-27-Mg, CPO-27-Co or other variants (i.e. wherein the metal ion in the MOF is different), and references to UiO-66 may include UiO-66-NH₂, UiO-66-Br, UiO-66-OH, or other variants (i.e. wherein the organic linker in the MOF is different). Furthermore, references to a MOF may include MOFs that are part of the same isoreticular series with the same secondary building unit (SBU) and topology but wherein the organic linker, functionality and/or pore size is varied. For example, references to IRMOF-1 may include IRMOF-8, IRMOF-11, IRMOF-18 (i.e. wherein the length, functionalization and/or catenation of the organic linker in the MOF is different).

MOFs also have advantages over other porous materials (e.g. activated carbon) due to their ability to be functionalised and fine-tuned for adsorption of specific materials. For instance, the unique properties of MOFs allow fine-tuning of the shape, size and chemical nature of the pores, making them ideal for gas separation, storage and purification processes (Eddaoudi et al., Science 2002, 295(5554), p. 469-472).

### COFs

COFs are organic framework materials that have structures created mostly or completely by covalent bonds using light, non-metallic elements such as carbon, nitrogen, hydrogen, oxygen, boron, silicon, phosphorus and sulphur. There are some similarities in porous structure to metal-organic framework materials (MOFs), but generally the chemistry and resulting structures, properties and behaviours are different to MOFs, and accordingly, manufacturing and processing conditions used for the manufacture of MOF materials are not necessarily applicable to manufacture and production of COF materials.

Due to the strength of the covalent bonds, COFs can display higher levels of chemical stability than many MOFs. This makes them highly interesting as gas storage materials. COFs can contain structures which are fundamentally 2-D (like graphite) or 3-D (like diamond). The distinction between 2-D and 3-D structures is a fundamental difference between COFs, especially for their physical stability. They can be synthesised under mild conditions using a variety of techniques including solution-based and mechano-synthetic routes. This is in contrast to MOF materials, which are bonded together by coordinative linkages, and thus generally have far lower levels of chemical stability. However, COF materials typically have low mechanical strength compared to other sorbent materials. This is especially true for 2-D COFs. The graphite-like stacked sheet structure of most 2-D COFs means that they are especially susceptible to shear deformation as the COF sheets slide over each other.

Particularly suitable COF compositions for use with the present invention include imine and/or hydrazone linked COF compositions. Examples of hydrazone-linked COFs include COF-42-bnn, COF-42-gra, COF-43-bnn, COF-43-gra, COF-ASB, COF-LZU8, CPF-1, CPF-2, and TFPT-COF. Examples of imine-linked COFs include 3D-COOH-COF, 3D-COOH-COF, 3D-CuPor-COF, 3D-CuPor-COF-0P, 3D-OH-COF, 3D-Por-COF, 3D-Por-COF-0, COFBTA-PDA, COF-DL229, COF-LZU1, COF-SDU1, COF-TpAzo, and CuP-Ph COF.

Preferably, the adsorbent material is a metal-organic framework (MOF) body selected from:
(i) Zr-containing MOFs;
(ii) Zn-containing MOFs such as Zeolite Imidazolate Frameworks, Zn-containing UTSA-16, CALF-15 and CALF-20.
(iii) MOF-74, MOF-274 and derivatives thereof;
(iv) Al-based MOFs;
(v) Fe-based MOFs;
(vi) MOFs of the M(F₆₋ₓ)Lₓ family;
(vii) Cu-based MOFs;
(viii) Co-based MOFs including Co-UTSA-16;
(ix) Cr-based MOFs
(x) Nb-based MOFs;
(xi) Ni-based MOFs;
(xii) Mn-based MOFs;
(xiii) mixed metal MOFs; and
(xiv) any combination thereof.

Suitable Zr containing MOFs include UiO-66, UiO-67, UiO-68, NU-1000, PCN-222, MOF-808 and Zr-fumarate.

Suitable ZIF monoliths include ZIF-8, ZIF-67, ZIF-71 and ZIF-90.

Suitable MOF-74s derivatives include Mn, Ni, Co, Cu and Zn variants.

Suitable Al-based MOFs include Al-fumarate, MIL-53, CAU-10, MIL-160(Al) and Al-soc-MOF-1.

Suitable Cr-based MOFs include MIL-101(Cr).

Suitable MOFs of the M(F₆₋ₓ)Lₓ family include SIFSIX-3-Ni, TIFSIX-3-Ni, NbOFFIVE-1-Ni and SIFSIX-2-Cu-i.

suitable Cu-based MOFs include HKUST-1 and ROS-37.

Suitable Co-based MOFs include Cobalt-based UTSA-16 and derivatives thereof.

Suitable Fe-based MOFs include MIL-100(Fe) and MIL-101(Fe).

Preferred MOFs may be selected from the group consisting of HKUST-1, ZIF-8, MOF-808, ZU-301, UTSA-16, CALF-20, CALF-15, TIFSIX-3-Ni, NbOFFIVE-1, MOF-74/CPO-27, SIFSIX, UiO-66, UiO-67, UiO-68, NU-1000, PCN-222, Al or Zr Fumarate, Al Formate or mixtures thereof.

Suitable adsorbent bodies comprising MOF body can include a body wherein:
(i) the MOF is selected from UiO-66 and/or derivatives thereof such as UiO-66-NH₂ and the first and second organic polymeric binder are independently selected from polyvinyl alcohol (PVA), polyimide, polyamide, methyl cellulose, and any combination thereof; or
(ii) the MOF compound is selected from ZIF-8 and/or derivatives thereof, and the first and second organic polymer binder are independently selected from PVA, methyl cellulose, and any combination thereof; or
(iii) the MOF is selected from Al-fumarate and/or derivatives thereof, and the first and second organic polymer binder are independently selected from PVA, polyamide, and any combination thereof; or
(iv) the MOF is selected from Zr-fumarate and/or derivatives thereof, and the first and second organic polymer binder are PVA; or
(v) the MOF is Co or Zn UTSA-16 and/or derivatives thereof, and the first and second organic polymeric binder are independently selected from polyvinyl alcohol, polyimide, polyamide, methyl cellulose, and any combination thereof.
(vi) The MOF is ZU-301 and and/or derivatives thereof, and the first and second organic polymeric binder are independently selected from polyvinyl alcohol, polyimide, polyamide, methyl cellulose, and any combination thereof.
(vii) The MOF is MOF-808 and and/or derivatives thereof, and the first and second organic polymeric binder are independently selected from polyvinyl alcohol, polyimide, polyamide, methyl cellulose, and any combination thereof.

Suitable mixed metal MOFs include MOFs based on mixtures of two or more metals selected from Fe, Ti and Zn.

Suitable MOFs can comprise mixed ligand or co-crystallite MOFs wherein the MOF comprises at least two chemically distinct organic ligands bonded to the same metal ion. This feature can help adjust the chemical behaviour of the MOF.

It may be preferred that the two chemically distinct organic ligands are chemical analogues. By chemical analogue it is meant that the structural aspects of the ligand, specifically the backbone as well as the moieties that are involved in the bonding to metal ions, are the same.

An especially preferred feature is for the chemical distinct organic ligands to be chemical analogues, such that the organic ligands have the same backbone structure but differ from each other due to the functionalisation of the backbone structure. The structural similarity of how the different organic ligand anions bond to the metal ions means that variants of a specific MOF can be formed. If the organic ligands are too dissimilar then the MOF may be amorphous or full of defects.

The use of such chemical analogues allows specific MOFs to be made having variable chemical properties. It may also be preferred that the two chemically distinct organic ligands comprise different backbone structures. The use of organic ligands having different backbone structures can allow for “defects” to be introduced in the monolith body, where the structure of the MOF is incomplete, or allow for more complex MOF structures. These defects can increase porosity in some situations.

### Polymeric Organic Binder Solution

The polymeric organic binder solution comprises the second polymeric organic binder and a first solvent. The polymeric organic binder solution can comprise a mixture of organic polymeric binders.

The polymeric organic binder solutions are typically formed by dissolving or dispersing the second polymeric organic binder into the first solvent, often at high temperature and with agitation. Typical weight ratios of second polymeric organic binder to first solvent range from about 1:50 to about 1:4 or even about 1:2 If the polymeric organic binder solution is too concentrated it may be hard to mix well with the precursor material. If it is too dilute it wastes first solvent and can limit the deposition efficiency of the second polymeric organic binder onto the surface of the adsorbent material. The polymeric organic binder solution can be formed prior to, or concurrently with, contact with the precursor material. However, it is preferred for the polymeric organic binder solution to be formed prior to contact with the precursor material so as to maximise mix homogeneity and contact of adsorbent material particles with binder material.

### Polymeric Organic Binder

The solubility of the first and second polymeric organic binder in the first solvent is the same or higher than the solubility of the first and second polymeric organic binder in the second solvent. Preferably, the solubility of the first and second polymeric organic binder in the first solvent is higher than the solubility of the first and second polymeric organic binder in the second solvent.

The first and second polymeric organic binder may be as described herein. Preferably, the first and second polymeric organic binder are independently selected from polyvinyl alcohol (PVA), polyvinyl acetate, polyvinyl alcohol/acetate copolymers, polyimide, polyamide, polyvinyl pyrrolidone, polyacrylates include polyacrylic acid, polycarboxylates, polyethylene glycols, poly(1,4-phenylene-ether-ether-sulfone) (PFEES), poly(tetrahydrofuran) (PTHF), polylactic acid and derivatives thereof or a biopolymer-based material such as polysaccharide gums including xantham gum, guar gum, alginate, chitosan, cellulose-based polymers such as cellulose, cellulose acetate, hydroxypropyl methyl cellulose (HPMC), methyl cellulose, ethyl cellulose, hydroxyethyl cellulose, hydroxypropyl methylcellulose phthalate (HPMCP), or any mixtures and combinations thereof. A preferred binder mixture comprises PVA and a cellulose-based polymer, especially hydroxyethyl cellulose or methyl cellulose.

Typically, between about 5% and about 85% of the total polymeric organic binder mass is added in solid form as the first polymeric organic binder in step (a) of step (1). Preferably, about 10% to about 75%, or about 15% to about 70%, or about 20% to about 60%, or about 30% to 55% of the total polymeric organic binder mass is added as the first polymeric organic binder in step (a) of step (1).

Typically, about 15% to about 95%, or about 25% to about 90%, or about 30% to about 85%, or about 40% to about 80%, or about 45% to about 70%, of the total polymeric organic binder mass is added as the second polymeric organic binder in step (b) of step (1).

The weight ratio of first polymeric organic binder to second polymeric organic binder added to the adsorbent material is from about 5:95 to about 50:50, or from about 10:90 to about 40:60, or from about 15:85 to about 35:65, or even from about 20:80 to about 30:70.

Note that the terms “organic polymeric binder” and “polymeric organic binder” are used interchangeably throughout this specification. For example, references to first polymeric organic binder means first organic polymeric binder and vice versa.

### First Solvent

The first solvent may be chemically the same as the second or third solvent or may be chemically different. Preferably the first solvent is chemically different from the second solvent. Preferably, the first solvent is water (a polar protic solvent). Polar, aprotic solvents are also preferred, including DMSO, dimethylformamide (DMF), dimethylacetamide (DMS) and N-methyl-2-pyrolidone. Other first solvents may include alcohols, glycols, acetone and distilled paraffin oils and mixtures thereof.

### Third Solvent

The third solvent may be chemically the same as the first or second solvent or may be chemically different. Preferably the third solvent is chemically different from the first and second solvent. Preferably, the third solvent is water (a polar protic solvent). Polar, aprotic solvents are also preferred, including DMSO, dimethylformamide (DMF), dimethylacetamide (DMS) and N-methyl-2-pyrolidone. Other first solvents may include alcohols, glycols, acetone and distilled paraffin oils and mixtures thereof. The third solvent may comprise mixtures of solvents.

### Solvated Adsorbent Mixture

The solvated adsorbent mixture comprises adsorbent material, first polymeric organic binder, second polymeric organic binder and first solvent (and optionally third solvent), wherein first and second polymeric organic binder is adsorbed onto the surface of the adsorbent material and wherein the first solvent (and optionally third solvent) is distributed throughout the solvated adsorbent mixture. The solvated adsorbent mixture may also comprise residual reactants (such as adsorbent material and/or adsorbent material precursors) and solvents from any previous process steps, such as the synthesis and washing of the adsorbent material.

The solvated adsorbent mixture comprises adsorbent material, first polymeric organic binder, second polymeric organic binder and first solvent (and optionally third solvent).

Typically, the solvated adsorbent material comprises adsorbent material and first and second polymeric organic binder at a weight ratio of adsorbent material to first and second polymeric organic binder of from about 0.75:1 to about 12.5:1 or from about 1:1 to about 9:1 or from about 2:1 to about 8:1. That is, the solvated adsorbent material comprises adsorbent material and first and second polymeric organic binder at a weight ratio of adsorbent material to the total combined weight of first polymeric organic binder and second polymeric organic binder of from about 0.75:1 to about 12.5:1 or from about 1:1 to about 9:1 or from about 2:1 to about 8:1.

Typically, the weight ratio of adsorbent material to the first and second polymeric organic binder present in the solvated adsorbent mixture may be in the range of from 2:1 to 9:1. Typically, the weight ratio of adsorbent material to the first and second polymeric organic binder (total combined weight of first polymeric organic binder and second polymeric organic binder) present in the solvated adsorbent mixture may be in the range of from 2:1 to 9:1 and wherein the ratio of the first binder to the second binder is between 1:4 to 4:1.

### Initial Adsorbent Body

Typically, the initial adsorbent body comprises first polymeric organic binder, second polymeric organic binder, adsorbent material, and any residual first (and optionally third) solvent. The initial adsorbent body may also comprise residual reactants (e.g. adsorbent material or adsorbent material precursors).

The initial adsorbent body will have the same ratio of adsorbent to organic polymeric binder as the solvated adsorbent mixture and will typically be mechanically very robust but have poor sorption capacity due to pore blockage.

The initial adsorbent body may be dried in step (e) as described herein for the reduced-binder adsorbent body.

### Second Solvent

The second solvent may be chemically the same as the first and third solvent or may be chemically different. Preferably the second solvent is chemically different from the first and third solvent. The second solvent can comprise mixtures of solvents, including mixtures comprising the first solvent. The second solvent can be the same as the first and third solvent but at a lower or different temperature so as to reduce the solubility of the first and second polymeric binder in the solvent. The solubility of the binder in the second solvent is preferably lower than in the first solvent (and optional third solvent).

Preferably, the second solvent is selected from alcohols and glycols. Preferably, the second solvent has a molecular weight of less than 600 Da. More preferably, the second solvent has a molecular weight of less than 600 Da and is selected from alcohols and glycols. Particularly preferred second solvents are methanol and ethanol. Typically, up to 40% of another solvent can be added to the second solvent. For example, 90:10 mixtures of methanol and water can be used as the second solvent.

### Reduced-Binder Adsorbent Body

The reduced-binder adsorbent body comprises adsorbent material, first polymeric organic binder, second polymeric organic binder, second solvent and residual first (and optionally third) solvent.

Typically, the weight ratio of first and second polymeric organic binder to adsorbent material in the reduced-binder adsorbent body is lower than the ratio of first and second polymeric organic binder to adsorbent material in the initial adsorbent body. Typically, it is beneficial to remove a proportion of the first and second polymeric organic binder, e.g., from the surfaces of the adsorbent material, and significantly increase the available surface area.

Typically, it is beneficial to remove at least about 2%, at least about 4%, or at least about 5% of the first and second polymeric binder to significantly improve the BET area of the body.

Preferably less than about 20% of the combined weight of the first and second polymeric organic binder is removed from the initial adsorbent body. Preferably from about 2% to about 20%, or from about 4% to about 15%, or from about 5% to about 10% of the combined weight of the first and second polymeric organic binder is removed from the initial adsorbent body. The amount that is removed is a variable dependent on the specific application and level of robustness needed. Some MOFs do not typically require this polymeric organic binder removal step. Removing high levels is not typically preferred.

The reduced-binder body may then be solvent dried in step (e), for example by heating, often under vacuum, to remove residual solvents and form the final, activated adsorbent body.

### Uses of Adsorbent Bodies As a Composition in Gas Storage Vessels

The inventive process can be used to produce an adsorbent body composition suitable for use in a gas storage vessel. The composition comprises one or more, or a plurality of, adsorbent bodies made according to the process defined herein. The composition may comprise one or more additives. The adsorbent bodies comprised in the composition may be spheres, extrudates, tablets, a thin layer or other suitably shaped bodies. The mean particle size of the adsorbent bodies may be less than about 5 mm, less than about 4 mm, less than about 3 mm, or less than about 2 mm.

A typical gas storage vessel comprises a body having external walls defining an internal volume, a gas inlet port configured to receive gas into the vessel, a gas outlet port configured to dispense gas from the vessel, a pressure relief valve configured to regulate internal pressure within the vessel.

The gas storage vessel may be a non-spherical gas storage vessel.

The gas storage vessel may further comprise one or more of the following:
a. insulation of the external walls;
b. means of heating and cooling the composition;
c. internal baffles to help gas move uniformly through the composition;
d. means for retaining the composition in place by use of permeable membranes and/or meshes;
e. means for retaining the composition in place such that the composition is more than about 10 cm from an external wall;
f. means of monitoring pressure and/or temperature; and/or
g. one or more valves to control gas input and output flows.

### Use of the Gas Storage Vessel

According to a further aspect of the present disclosure, there is provided a use of the gas storage vessel comprising the composition as defined herein for the uptake, storage and/or release of a gas. In a further aspect there is provided a composition as defined herein for the uptake, storage and/or release of a gas.

The composition is particularly suited for the sorption and storage of gases for various gas separation and purification applications. Due to the porous nature of the adsorbent bodies (e.g. MOF and/or COF monolithic bodies) in the composition, as well as other properties such as high bulk density, they are particularly suited for demonstrating a high volumetric capacity of gas, which is important for gas storage and separation applications.

The MOF and/or COF may be selected based on the use of the gas storage vessel or composition. For example, the MOF and/or COF may have a chemical composition, porosity, pore size etc. that is particularly suited for a certain gas storage and separation application.

The gas may comprise one or more of the following hydrogen, carbon dioxide, methane, krypton or mixtures thereof.

The uptake and/or release of the gas may be achieved by:
a. a pressure-swing process; and/or
b. a temperature-swing process.

In some embodiments, the use of the gas storage vessel or the composition is part of a gas purification process.

The gas storage vessel can be used as part of gas purification, storage and capture processes, for example as part of pressure-swing (PSA) or temperature-swing (TSA) adsorption processes and variations thereof, such as VPSA (vacuum pressure-swing adsorption).

Such processes operate by varying the pressures and temperatures inside the gas storage vessel such that the target gas (e.g. hydrogen, carbon dioxide, methane, krypton or mixtures thereof) is either adsorbed by the adsorbent bodies or is desorbed from the adsorbent bodies.

For example, in order to load and store hydrogen onto the monolithic adsorbent bodies, hydrogen gas is introduced into the vessel at high pressures (typically >5 bar (500 kPa)) and low temperatures (such as below 100 K). This cools the adsorbent bodies down and assists the adsorption of the hydrogen into the adsorbent body (e.g. a MOF). The cooled and pressurised hydrogen is typically fed into the storage vessel until the pressure in the vessel is at, or close to, the pressure and temperature of the incoming gas. The adsorbent bodies are then loaded with hydrogen so it can be stored until needed. To remove the hydrogen from the storage vessel, one or more valves are opened to allow the release of the pressurised gas. As the pressure drops, hydrogen desorbs from the surfaces of the adsorbent bodies (e.g. the MOF surfaces) and can be removed through the valve. To assist in the gas removal, heat can be applied to increase the temperature of the adsorbent bodies and the pressure can be reduced. A similar approach may be used for other gases, such as methane, carbon dioxide, krypton or mixtures thereof, though the optimum pressures and temperatures for sorption and desorption will vary between gases.

The vessels can also be used as part of a purification or capture process, for example of gas containing carbon dioxide, krypton, methane, hydrogen or mixtures thereof. The gas stream to be separated, such as a flue gas containing carbon dioxide as part of a carbon capture process, is passed through the gas storage vessel at high pressures and lower temperatures—for example at >5 bar (500 kPa) and at lower, e.g., ambient, temperatures. The target gas, e.g., carbon dioxide and/or krypton, is then adsorbed by the adsorbent bodies (e.g. MOF body) which has been selected for a high selectivity for that gas compared to the other constituents of the gas stream. The gas coming out of the gas storage vessel is now depleted in the target gas and can be sent for further processing or vented to atmosphere. The gas stream is stopped when the adsorbent bodies (e.g. MOF bodies) are saturated with the target gas and stop adsorbing. The adsorbed target gas, such as carbon dioxide or krypton, is then desorbed from the adsorbent bodies (e.g. MOF bodies) by either increasing the temperature of the adsorbent bodies (e.g. MOF bodies)—e.g. by the use of heaters—for TSA processes or lowering the pressure in the storage vessel for PSA processes by opening valves and/or the use of pressure pumps, or both. The target gas is drawn off through an opened valve and sent on for further processing, such as underground capture.

### Use of the Gas Storage Vessel or the Composition for Hydrogen

In some embodiments, the gas comprises hydrogen and the first MOF monolithic body and/or the second MOF monolithic body comprise(s) a MOF wherein the MOF is selected from one or more of the following HKUST-1, ZIF-8, MOF-808, UiO-66 or mixtures thereof.

These MOFs show particularly excellent performance for the uptake, storage and release of hydrogen, and when used in the composition of the invention, demonstrate excellent performance such as volumetric performance, e.g. the volume of gas that can be stored.

When the gas comprises hydrogen and the first MOF monolithic body and/or the second MOF monolithic body comprise(s) a MOF wherein the MOF is selected from one or more of the following HKUST-1, ZIF-8, MOF-808, ZU-301, UiO-66 or mixtures thereof, the temperature of the composition may be varied from about −200 to about −100 °C during the uptake and/or release of the gas. When the temperature is at about −200 °C, the pressure inside the gas storage vessel may be greater than or equal to about 10 bar (1000 kPa). When the temperature is at about −100 °C, the pressure inside the gas storage vessel may be less than about 1 bar (100 kPa).

When the gas comprises hydrogen and the first MOF monolithic body and/or the second MOF monolithic body comprise(s) a MOF wherein the MOF is selected from one or more of the following HKUST-1, ZIF-8, MOF-808, ZU-301, UiO-66 or mixtures thereof, the composition may comprise a bulk volumetric composition of MOF of from about 0.4 g/cm³ to about 1.1 g/cm³ , preferably from about 0.6 to about 0.8 g/cm³ and hydrogen of from about 0.025 g/cm³ to about 0.09 g/cm³ , preferably from about 0.04 to about 0.065 g/cm³ at 77 K and 10 atm (1013.25 kPa). Bulk volumetric composition is obtained by dividing the mass of each of the components in the gas storage vessel by the volume of the gas storage vessel.

### Use of the Gas Storage Vessel or the Composition for Carbon Dioxide

In some embodiments, the gas comprises carbon dioxide and the first MOF monolithic body and/or the second MOF monolithic body comprise(s) a MOF wherein the MOF is selected from one or more of the following UTSA-16, CALF-20, ZU-301, TIFSIX-3-Ni, NbOFFIVE-1, UiO-66-NH₂ or mixtures thereof. Preferably, the MOF is ZU-301 and/or UTSA-16. ZU-301 and UTSA-16 demonstrate particularly excellent properties such as high volumetric performance, fast gas kinetics and good stability that are particularly suited for carbon dioxide capture in flue gas purification applications.

When the gas comprises carbon dioxide and the first MOF monolithic body and/or the second MOF monolithic body comprise(s) a MOF wherein the MOF is selected from one or more of the following UTSA-16, CALF-20, ZU-301, TIFSIX-3-Ni, NbOFFIVE-1-Ni, UiO-66-NH₂ or mixtures thereof, the temperature of the composition may be varied from about 0 to about 100 °C during the uptake and/or release of the gas. When the temperature is at about 20 °C, the pressure inside the gas storage vessel may be from about 5 bar (500 kPa) to about 10 bar (1000 kPa). When the temperature is at about 70 °C, the pressure inside the gas storage vessel may be less than about 1 bar (100 kPa).

In some embodiments, when the gas comprises carbon dioxide and the first MOF monolithic body and/or the second MOF monolithic body comprise(s) a MOF wherein the MOF is selected from one or more of the following UTSA-16, CALF-20, ZU-301, TIFSIX-3-Ni, NbOFFIVE-1-Ni, UiO-66-NH₂ or mixtures thereof, the composition may comprise a bulk volumetric composition of MOF of from about 0.4 g/cm³ to about 1.1 g/cm³ , preferably from about 0.6 to about 0.8 g/cm³ and carbon dioxide of from about 0.03 to about 0.14 g/cm³ , preferably from about 0.05 to about 0.1 g/cm³ at 293 K and 5 atm (506.625 kPa).

In some embodiments, the gas entering the gas storage vessel has a carbon dioxide content of from about 0.1 to about 10 wt %.

In other embodiments, the gas entering the gas storage vessel has a carbon dioxide content of from about 10 to about 70 wt %.

### Use of the Gas Storage Vessel or the Composition for Krypton

In some embodiments, the gas comprises krypton and the first MOF monolithic body and/or the second MOF monolithic body comprise(s) a MOF wherein the MOF is MOF-74, preferably MOF-74-Mg.

When the gas comprises krypton and the first MOF monolithic body and/or the second MOF monolithic body comprise(s) a MOF wherein the MOF is MOF-74, the temperature of the composition may be varied from about 0 to about 100 °C during the uptake and/or release of the gas. When the temperature is about 20 °C, the pressure inside the gas storage vessel may be greater than or equal to about 5 bar (500 kPa). When the temperature is about 100 °C, the pressure inside the gas storage vessel may be less than about 1 bar (100 kPa).

In some embodiments, the gas entering the gas storage vessel has a krypton content of from about 90 to about 99 wt %.

When the gas comprises krypton and the first MOF monolithic body and/or the second MOF monolithic body comprise(s) a MOF wherein the MOF is MOF-74, the composition may comprise a bulk volumetric composition of MOF of from about 0.4 to 1.1 g/cm³ , preferably from about 0.6 to about 0.8 g/cm³ and krypton of from about 0.03 to 0.14 g/cm³, preferably from about 0.05 to about 0.1 g/cm³ at 293 K and 5 atm (506.625 kPa).

### Use of the Gas Storage Vessel or the Composition for Methane

In some embodiments, the gas comprises methane and the first MOF monolithic body and/or the second MOF monolithic body comprise(s) a MOF wherein the MOF is HKUST-1. When the gas comprises methane and the first MOF monolithic body and/or the second MOF monolithic body comprise(s) a MOF wherein the MOF is HKUST-1, the temperature of the composition may be varied from about 0 to about 100 °C during the uptake and/or release of the gas. When the temperature is about 20 °C, the pressure inside the gas storage vessel may be greater than or equal to about 5 bar (500 kPa). When the temperature is greater than about 95 °C, the pressure inside the gas storage vessel may be less than about 1 bar (100 kPa).

When the gas comprises methane and the first MOF monolithic body and/or the second MOF monolithic body comprise(s) a MOF wherein the MOF is HKUST-1, the composition may comprise a bulk volumetric composition of MOF of from about 0.4 to 1.1 g/cm³, preferably from about 0.6 to about 0.8 g/cm³ and methane of from about 0.03 to 0.14 g/cm³, preferably from about 0.05 to about 0.1 g/cm³ at 293 K and 5 atm (506.625 kPa).

### Clarifications

Throughout this specification, one or more aspects of the invention may be combined with one or more features described in the specification to define distinct embodiments of the invention.

References herein to a singular of a noun encompass the plural of the noun, and vice-versa, unless the context implies otherwise. For example, the term adsorbent body should be understood to also refer to adsorbent bodies.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The term ‘comprising’ includes within its ambit the term ‘consisting’ or ‘consisting essentially of’.

The term ‘consisting’ or variants thereof is to be understood to imply the inclusion of a stated element, integer or step, or group of elements, integers or steps, and the exclusion of any other element, integer or step or group of elements, integers or steps.

The term ‘consisting essentially of’ or variants thereof is to be understood to imply the inclusion of a stated element, integer or step, or group of elements, integers or steps, and that further components may be present, but only those not materially affecting the essential characteristics of the formulation, composition, or compound.

The term ‘about’ as used herein, when qualifying a number or value, is used to refer to values that lie within ±5% of the value specified.

Each and every reference referred to herein is hereby incorporated by reference in its entirety, as if the entire content of each reference was set forth herein in its entirety.

While particular examples and/or embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Test Methods

### Mean Particle Size Measurement by XRD

The weight average particle size of adsorbent material in an adsorbent body can be measured by X-Ray diffraction (XRD). The weight average particle size of the adsorbent material making up the adsorbent body can be determined by X-ray diffraction using the Scherrer equation to calculate particle size from the full-width at half maximum (FWHM) measure of the diffraction peak. The adsorbent material particles are often quite isotropic in shape with no single preferred orientation of crystallite growth so the choice of which reflection to use is not critical but for consistency, the (0 1 0) reflection is used, and the K value is constant at 0.94. Suitable equipment includes the X'Pert Pro from PANalytical.

### Measurement of Adsorbent Material Particle Size Prior to Step (a)

The particle size distribution of the adsorbent particles can also be measured prior to step (a) if in a slurry or suspension by dynamic light scattering techniques (DLS). XRD however is the preferred method. Suitable equipment for DLS includes the NANO-flex II from Colloid Metrix. Dilution of the suspension is usually not required.

### Method of Measuring Binder Solubility in a Solvent

The solubility of a binder in a solvent can be determined by adding 10 g of the binder in powdered form to 90 g of solvent at ambient temperature and stirring for four hours. After this a weighed sample of mix should be put into a weighed Falcon tube and centrifuged at >1000 g for 20 minutes. The liquid should then be decanted and the solid pellet dried at 150 °C until no further loss of weight and the dry weight of binder then measured. The % solubility is the difference in weights between the amount of binder in the mix originally added and the weight of the residual pellet divided by the weight of the solvent originally added and multiplied by 100. If all of the binder dissolves during the test, a further 10 g of binder should be added and the mixture stirred for a further two hours. If need be, this is repeated until solid binder remains at the end of the stirring period such that the measured solubility is the saturation solubility.

### Method for Measuring the BET Area of an Adsorbent Body.

The BET surface area of an adsorbent body can be measured by use of ASTM method D3663-03 “Standard test method for surface area of catalysts and catalyst carriers”. The BET surface area is determined by measuring the volume of nitrogen gas adsorbed at various low-pressure levels by the monolith sample. Pressure differentials caused by introducing the monolith surface area to a fixed volume of nitrogen in the test apparatus are measured and used to calculate BET surface area. Suitable equipment for measuring BET surface area include the 3Flex from Micromeritics Corporation, used according to the manufacturer's guidelines.

### Method of Measuring Micro-Porosity of an Adsorbent Body

The MOF body preferably a micro-porosity of greater than 40% and less than 75% of the total pore volume as measured by N₂ adsorption. Some mesoporosity (having larger pores than micropores but smaller than macropores) may beneficially assist the transfer of fluids throughout the MOF body.

The micro and meso-porosity profile of a body can be determined by test method ASTM D 4641-17. Suitable equipment for carrying out such tests is the ASAP 2020 Plus, from Micromeritics Corporation. The test method is as follows.

The test sample (0.5 g) is typically heated to 300 °C under vacuum to remove adsorbed gases and vapours from the surface. The nitrogen adsorption branch of the isotherm is then determined by placing the sample under vacuum, cooling the sample to the boiling point of liquid nitrogen (~77.3 K), and then adding, in a stepwise manner, known amounts of nitrogen gas at increasing pressure P to the sample in such amounts that the form of the adsorption isotherm is adequately defined, and the saturation pressure of nitrogen is reached.

Each additional dose of nitrogen is introduced to the sample only after the preceding dose of nitrogen has reached adsorption equilibrium with the sample.

Typically, equilibrium is reached if the change in gas pressure is no greater than 0.1 torr/5 min interval. This is continued until P₀ (the gas saturation pressure) is reached.

Data is typically plotted as the amount of gas adsorbed/desorbed (and derived porosity profiles) as a function of P/P₀. The desorption isotherm is determined by desorbing nitrogen from the saturated sample in a stepwise manner with the same precautions taken to ensure desorption equilibration as those applied under adsorption conditions. Microporosity is associated with the volume of gas adsorbed at P/P₀ values of <0.1 whereas mesoporosity is associated with the volume of gas adsorbed at P/P₀ values between 0.1 and 0.98.

### Method of Measuring Macroporosity by Mercury Porosimetry

In order to have a MOF monolithic body with a high volumetric performance for gas storage and separation applications, it is preferable that the first and/or second MOF monolithic bodies have a low level of macropores. In other words, the first and/or second MOF monolithic bodies may have a low level of macroporosity or a low volume of macropores in proportion to the volume (i.e. envelope volume) of the first and/or second MOF monolithic bodies.

The macroporosity of the MOF monolithic bodies may be determined by mercury porosimetry. Methods based on N₂ adsorption methods are suitable for micro-and mesoporosity but are unsuitable for larger macropores. Mercury porosimetry can measure macropores but cannot measure micropores or the smaller mesopores.

The mercury porosity values can be measured according to ASTM D4284-12. Suitable equipment for carrying out ASTM D4284-12 include the Micromeritics AutoPore VI 9510 from Micromeritics Corp, USA. Other suitable equipment includes the PoreMaster series from Quantachrome. Unless otherwise specified by the equipment manufacturer, the default surface tension and contact angle of mercury are taken as being 485 mN/m and 130°, respectively. In ASTM D4284-12, mercury is forced into pores under pressure. A sample size of ~0.2 g is preferably used. The MOF monolithic bodies are preferably fragmented and sieved between 710 microns and 250 microns, and the sieved material used.

The pressure required to force mercury into the pores of the sample is inversely proportional to the size of the pores according to the Washburn equation. It is assumed that all pores are cylindrical for the purpose of characterisation. The porosimeter increases the pressure on the mercury inside the sample holder to cause mercury to intrude into increasingly small sample pores. The AutoPore VI or other suitable equipment will automatically translate the applied pressures into equivalent pore diameters using the Washburn equation and the values of contact angle and surface tension given above.

The envelope volume may be measured using techniques based on the Archimedes principle of volume displacement. The envelope volume of the sample is determined by the volume of mercury displaced at atmospheric pressure. At atmospheric (101.325 KPa) pressure, mercury does not intrude into internal pores, just external pores. Therefore, the volume of mercury displaced by a body at 101 KPa pressure may be used as the envelope volume.

As the applied pressure is increased, mercury is forced into smaller internal pores. A pressure of 292 atmospheres (2.96×10⁴ KPa) is sufficient to force mercury into pores of 50 nm and larger. Therefore, the % level of macroporosity of a sample is the % Hg Intrusion Porosity at 2.96×10⁴ KPa minus the % Hg Intrusion Porosity at 101 KPa.

Mercury porosimetry is not suitable for measuring micro and meso-porosity as the pressures required to force mercury into the small pores are too high to be practical.

### Method for Measuring the Envelope Density of an Adsorbent Body

The adsorbent body may have an envelope density greater than 0.4 g/cm³, or greater than 0.6 g/cm³ or greater than 0.8 g/cm³, or greater than 1.0 g/cm³.

The envelope density of a body can be measured by dividing the weight of a body (in grams) by its envelope volume (in mm³). The envelope volume is defined in ASTM D3766 as “the ratio of the mass of a particle to the sum of the volumes of the solid in each piece and the voids within each piece, that is, within close-fitting imaginary envelopes completely surrounding each piece”. The envelope density of a body can be measured using techniques based on the Archimedes principle of volume displacement. For example, the envelope density can be measured by mercury porosimetry. At atmospheric pressure, mercury does not intrude into internal pores. Therefore, the volume of mercury displaced by a body at atmospheric pressure is the envelope volume of the body. Dividing the weight of the sample by this volume gives the envelope density. The use of mercury porosimetry is described above.

An alternative, and viable, technique for larger bodies, typically those with a diameter >2 mm, is to use accurate 3-D scanners to measure the body volume. Suitable equipment includes the Leica BLK360.

Preferably, powder pycnometers, such as the GeoPyc Model 1360 from Micrometrics Instrument Corp, can also be used to measure the envelope volumes and densities of bodies. If need be, the envelope volumes measured by these techniques can be used interchangeably with the envelope volume measured by mercury porosimetry.

### Method for Determining the Level of Binder in an Adsorbent Body

The level of the polymeric organic binder in a MOF adsorbent body can be determined by thermo-gravimetric methods based on weight loss at elevated temperatures.

The high temperatures used (600 °C) will burn off all the organic species from a sample leaving only metal oxide species behind. The difference in % weight loss between a sample of the MOF adsorbent material and a sample of the MOF adsorbent body (adsorbent material plus binder) can be used to determine the level of binder in that sample.

The MOF adsorbent body being tested is first dried by heating to 150 °C for 1 hour to remove solvent. The body is then crushed and a sample (typically 1 g) of the adsorbent body material is heated up to 600 °C and the weight loss when at steady state (usually after 1 hr) is measured and normalised as a % loss and % residue. A sample of the adsorbent material forming the adsorbent body is dried and then heated under identical conditions and the weight loss normalised as a % loss and hence giving a % residue. The % of MOF in the adsorbent body is the % residue of the adsorbent body divided by the % residue of the adsorbent material. The % level of binder is 100% minus the % of MOF in the adsorbent body.

To measure the % weight loss of binder by contact with a second solvent, samples before and after the binder removal step are tested as above. This will generate two % levels of binder—IABB % (Initial Adsorbent Body Binder %) and RBABB % (Reduced Binder Adsorbent Body Binder %).

The % loss of binder is therefore ((IABB %−RBABB %)/(IABB %))*100.

### Assessment of Mechanical Integrity

The relative mechanical integrity of the adsorbent MOF bodies can be assessed by placing 10 g of adsorbent MOF bodies in a sealed glass jar (200 ml capacity can be suitable) and shaking vigorously by hand for 1 minute. The robustness of the adsorbent bodies can be visually assessed and compared by the relative amounts of dust on the inside surfaces of the glass jar.

### Method of Measuring Relative Density

Relative density refers to the ratio of the envelope density of a crystalline adsorbent body compared to the crystal density of the adsorbent material, i.e. the relative density is defined as the envelope density of the MOF or COF body divided by the crystal density of the MOF or COF.

The crystal density of a MOF or other crystalline material is the density of a single crystal and is calculated theoretically from the structure. Structural and other information for MOFs and other crystalline adsorbent material is available from the Cambridge Structural Database.

Relative densities of much less than 1, such as less than 0.3, mean that there is excess porosity, mostly in the form of larger (hence less useful) pores in the body. Relative densities greater than 1 imply a wasteful loss of porosity as such high values can only be achieved by destroying some of the useful pores.

Adsorbent bodies preferably have a relative density of from greater than 0.3 or from greater than 0.5 or from great than 0.7 to less than 1.2.

### Method of Measuring the Bulk Density of a Powder

The bulk density of a powder can be measured by completely filling a suitable cylindrical vessel of known volume, tapping the vessel at least 100 times and measuring the mass and volume of the material. The skilled person will appreciate dimensions of the vessel are not fixed as an appropriate size of vessel will be dependent on the powder being measured. There is no restriction on upper limit on the volume of the vessel, although larger volumes may require prohibitively expensive amounts of powder material to fill them and do not add useful information.

The mass and volume of the empty vessel are measured. The vessel is then filled by pouring the powder into the vessel from ~5 cm above the height of the vessel. The top of the poured powder is levelled with the top of the vessel. The combined mass of the vessel and the contained powder is then measured. The mass of the powder is calculated by deducting the mass of the empty vessel from the combined mass of the vessel and powder. The vessel is then tapped and the new volume of the tapped mass is measured. The bulk density is then calculated by dividing the mass of the powder by the volume of the powder.

### Method of Measuring Bulk Volumetric Composition

The mass of a component (e.g. MOF or gas) in the gas storage vessel is measured. The volume of the gas storage vessel is measured. Bulk volumetric composition is obtained by dividing the mass of each of the components in the gas storage vessel by the volume of the gas storage vessel. This method can be carried out for MOFs and gases.

### Example—Production of an Adsorbent Body Comprising UiO-66-NH₂ and Methylcellulose

1 litre of a reaction mix comprising MOF (UiO-66-NH₂) crystallites having a mean particle size of less than 900 nm dispersed in a reaction solvent comprising water and having a solids content of 10wt % is prepared.

The sample is divided into four equal aliquots and each aliquot is centrifuged in a Jeol JR15 for 15 minutes at 5250 g.

The supernatant liquid is poured off from each sample flask leaving a wet layer of solid at the bottom of the flask. 250 g of water is then added to each flask and the sample is agitated to redisperse and wash the crystallites.

The flasks is then re-centrifuged for 40 minutes at 5250 g to form a thick solid layer (the wet framework mass) comprising MOF, water and any residual reactants/solvents from the reaction mix. The supernatant liquid is poured off from each sample flask leaving a wet layer of solid at the bottom of the flask. The solid layer has a solids content of 27.5 wt %.

280 g of the wet framework mass is then mixed for one hour with 15 g of finely powdered methylcellulose (first organic polymeric binder) to form a precursor material. The precursor material is much thicker and solid like than the wet framework mass.

The precursor material is then mixed with 100 g of a 4% aqueous solution of methylcellulose (second organic polymeric material) to form a solvated adsorbent mixture.

The solvated adsorbent mixture is then extruded through a spaghetti maker onto a tray and dried at ambient conditions until hard. The extrudates are then broken manually to form initial adsorbent bodies.

1.2 g of the extrudates are then placed in 100 ml of methanol (second solvent) for 10 hours. The washed extrudates (washed adsorbent bodies) are removed from the methanol and allowed to dry under ambient conditions. This step reduces the amount of methylcellulose in the bodies by 10 wt %. The bodies are then activated by being heated to 105 °C in a vacuum oven for 12 hours to give the final adsorbent bodies. The activated beads (final adsorbent bodies) are robust and have a high BET area.

### Addition of Binder as a Powder or as a Solution

Without wishing to be bound by theory, the Inventors have found that adding all of the binder as a powder can result in weaker adsorbent bodies and/or lower density adsorbent bodies. This is believed to be due to the binder being poorly dispersed with the adsorbent material. The Inventors have found that HKUST-1 adsorbent bodies made with methyl cellulose as binder in powder form have poorer physical properties (e.g. strength, density and so on) than extrudates made with methyl cellulose as a binder solution.

This is believed to be due to partially dispersed binder particles resulting in the formation of an adsorbent body having a more macroporous structure compared to an adsorbent body formed when methyl cellulose binder was added as a solution. Addition of binder as a solution results in a more uniform dispersion of binder and adsorbent material.

However, adding all the binder as a (dilute) solution made processing more difficult as extensive drying was required. Combining both solid and liquid binder addition gave an adsorbent body with improved robustness and density to within acceptable limits whilst also limiting the amount of solvent evaporation required.

Aspects of the present invention are further described with reference to the following numbered paragraphs:
1. A process of making an adsorbent body comprising metal-organic framework (MOF) and/or covalent-organic framework (COF), wherein the process comprises the steps of:
   (a) contacting adsorbent material with a polymeric organic binder powder to form a precursor material, wherein the adsorbent material is selected from metal-organic frameworks or precursors thereof, covalent-organic frameworks or precursors thereof and any combination thereof, wherein the polymeric organic binder powder comprises a first polymeric organic binder, and wherein the precursor material comprises adsorbent material and first polymeric organic binder;
   (b) contacting the precursor material with a polymeric organic binder solution to form a solvated adsorbent mixture in a first solvent, wherein the polymeric organic binder solution comprises a second polymeric organic binder and a first solvent, wherein the solvated adsorbent mixture comprises adsorbent material, first polymeric organic binder, second polymeric organic binder, and first solvent, wherein first polymeric organic binder and second polymeric organic binder are adsorbed onto the surface of the adsorbent material and wherein the first solvent is distributed throughout the solvated adsorbent mixture;
   (c) subjecting the solvated adsorbent mixture to a body forming process, wherein the process comprises:
      (i) at least one process step selected from the group consisting of spreading, extrusion, cutting, milling, sieving, molding, granulation, pressing and tabletting; and
      (ii) a solvent drying step comprising removing at least some of the first solvent from the solvated adsorbent mixture to form an initial adsorbent body; and
   (e) solvent-drying to form the adsorbent body.
2. A process according to paragraph 1 wherein the process further comprises step (d) contacting the initial adsorbent body with a second solvent to in a solvent washing step to form a reduced-binder adsorbent body, wherein during step (d) residual reactants, residual first solvent and at least 2% of the combined weight of the first and second polymeric organic binder is removed from the initial adsorbent body and is dissolved into the second solvent, wherein the reduced-binder adsorbent body comprises adsorbent material, first polymeric organic binder, second polymeric organic binder, second solvent, and residual first solvent, wherein first polymeric organic binder and second polymeric organic binder are adsorbed onto the surface of the adsorbent material and wherein the second solvent is distributed throughout the reduced-binder adsorbent body.
3. A process according to paragraph 1 or paragraph 2 wherein the adsorbent material in step (a) is provided in a third solvent.
4. A process according to any preceding paragraph wherein the adsorbent material is a MOF.
5. A process according to any one of paragraphs 2 to 4 wherein the solubility of the first polymeric organic binder and the second polymeric organic binder in the first solvent is higher than the solubility of the first polymeric organic binder and the second polymeric organic binder in the second solvent.
6. A process according to any preceding paragraph, wherein the first polymeric organic binder is different to the second polymeric organic binder.
7. A process according to any preceding paragraph, wherein the first polymeric organic binder is the same as the second polymeric organic binder.
8. A process according to any one of paragraphs 2 to 7, wherein between greater than 2% and less than 20% of the combined weight of the first and second polymeric organic binder is removed from the initial adsorbent body in step (d).
9. A process according to any preceding paragraph, wherein the weight ratio of adsorbent material to the first and second polymeric organic binder present in the solvated adsorbent mixture is in the range of from 2:1 to 9:1 and wherein the ratio of the first binder to the second binder is between 1:4 to 4:1.
10. A process according to any preceding paragraph, wherein the weight ratio of adsorbent material to the first and second polymeric organic binder present in the adsorbent body is greater than 3:1.
11. A process according to any preceding paragraph, wherein the adsorbent material is in particulate form having a mean particle size less than 900 nm.
12. A process according to any preceding paragraph wherein the solvent-drying step in step (c) is a low temperature drying step wherein the drying step is carried out at a temperature of less than 50 °C, for a period of time of longer than 5 hours, and at pressure of from 0.5 to 1.0 bar, and wherein the first solvent has a boiling point of 100°C or less;
13. A process according to any preceding paragraph, wherein the adsorbent material is a metal-organic framework (MOF) body selected from the group consisting of HKUST-1, ZIF-8, MOF-808, ZU-301, UTSA-16, CALF-20, CALF-15, TIFSIX-3-Ni, NbOFFIVE-1, MOF-74/CPO-27, SIFSIX, UiO-66, UiO-67, UiO-68, NU-1000, PCN-222, Al or Zr Fumarate, Al Formate or mixtures thereof.
14. A process according to any preceding paragraph, wherein the first polymeric organic binder and the second polymeric organic binder are independently selected from polyvinyl alcohol (PVA), polyvinyl acetate, polyvinyl alcohol/acetate copolymers, polyimide, polyamide, polyvinyl pyrrolidone, polyacrylates include polyacrylic acid, polycarboxylates, polyethylene glycols, poly(1,4-phenylene-ether-ether-sulfone) (PFEES), poly(tetrahydrofuran) (PTHF), polylactic acid and derivatives thereof or a biopolymer-based material such as polysaccharide gums including xantham gum, guar gum, alginate, chitosan, cellulose-based polymers such as cellulose, cellulose acetate, hydroxypropyl methyl cellulose (HPMC), methyl cellulose, ethyl cellulose, hydroxyethyl cellulose, hydroxypropyl methylcellulose phthalate (HPMCP), or any mixtures and combinations thereof.
15. A process according to any one of paragraphs 2 to 13, wherein the second solvent is selected from alcohols and glycols, and wherein the second solvent has a molecular weight of less than 600 Da.
16. A process according to any preceding paragraph wherein the adsorbent body further comprises a material selected from:
   (a) nanoparticles of metals and metal salts;
   (b) enzymes;
   (c) magnetic materials;
   (d) dyes and pigments;
   (e) graphene and graphene oxide; and
   (f) any combination thereof.
17. A composition comprising a plurality of adsorbent bodies made according to the process as defined in any preceding paragraph.
18. A gas storage vessel comprising the composition as defined in paragraph 17.
19. The gas storage vessel according to paragraph 18, wherein the gas storage vessel further comprises one or more of the following:
   a. insulation of the external walls;
   b. means of heating and cooling the composition;
   c. internal baffles;
   d. means for retaining the composition in place;
   e. means for retaining the composition in place such that the composition is more than about 10 cm from an external wall;
   f. means for monitoring pressure and temperature; and/or
   g. valves to control gas input and output flows.
20. Use of the gas storage vessel as defined in paragraph 18 or paragraph 19 or a composition as defined in paragraph 17 for the uptake, storage and/or release of a gas.
21. The use according to paragraph 20, wherein the gas comprises one or more of the following hydrogen, carbon dioxide, methane, krypton or mixtures thereof.
22. The use according to paragraph 20 or paragraph 21, wherein the use is part of a gas purification process.
23. The use according to any one of paragraphs 20 to 22, wherein the gas comprises hydrogen and the MOF is selected from one or more of the following HKUST-1, ZIF-8, MOF-808, ZU-301, UiO-66 or mixtures thereof.
24. The use according to paragraph 23, wherein the composition comprises a bulk volumetric composition of MOF of from about 0.6 to about 0.8 g/cm³ and hydrogen of from about 0.04 to about 0.065 g/cm³ at 77 K and 10 atm.
25. The use according to any one of paragraphs 20 to 22, wherein the gas comprises carbon dioxide and the MOF is selected from one or more of the following UTSA-16, CALF-20, ZU-301, TIFSIX-3-Ni, NbOFFIVE-1, UiO-66-NH₂ or mixtures thereof, preferably ZU-301.
26. The use according to paragraph 25, wherein the composition comprises a bulk volumetric composition of MOF of from about 0.6 to about 0.8 g/cm³ and carbon dioxide of from about 0.05 to about 0.1 g/cm³ at 293 K and 5 atm.
27. The use according to any one of paragraphs 20 to 22, wherein the gas comprises krypton and the MOF is MOF-74-Mg.
28. The use according to paragraph 27, wherein the composition comprises a bulk volumetric composition of MOF of from about 0.6 to about 0.8 g/cm³ and krypton of from about 0.05 to about 0.1 g/cm³ at 293 K and 5 atm.
29. The use according to any one of paragraphs 20 to 22, wherein the gas comprises methane and the MOF is HKUST-1.
30. The use according to paragraph 29, wherein the composition comprises a bulk volumetric composition of MOF of from about 0.6 to about 0.8 g/cm³ and methane of from about 0.05 to about 0.1 g/cm³ at 293 K and 5 atm.
31. The composition according to paragraph 17, wherein the adsorbent material comprises a metal-organic framework (MOF) and the adsorbent body comprises:
   (a) at least 50 wt % metal-organic framework (MOF) particles; and
   (b) from 2.0 wt % to 25 wt % organic polymeric binder, wherein the organic polymeric binder comprises first polymeric organic binder and second polymeric organic binder,
wherein the adsorbent body has:
   (i) an envelope density of greater than 0.5 g/cm³;
   (ii) a relative density of from greater than 0.4 to less than 1.2;
   (iii) a BET area of greater than 10 m²/g, preferably greater than 100 m²/g, preferably greater than 300 m²/g, preferably greater than 500 m²/g;
   (iv) a micro-porosity of greater than 40% of the total pore volume as measured by N₂ adsorption; and
   (v) a macro-porosity of less than 15%, preferably less than 10% as measured by mercury porosimetry.

1-31. (canceled)

32. A process of making an adsorbent body comprising metal-organic framework (MOF) and/or covalent-organic framework (COF), wherein the process comprises the steps of:
(a) contacting adsorbent material with a polymeric organic binder powder to form a precursor material, wherein the adsorbent material is selected from metal-organic frameworks or precursors thereof, covalent-organic frameworks or precursors thereof and any combination thereof, wherein the polymeric organic binder powder comprises a first polymeric organic binder, and wherein the precursor material comprises the adsorbent material and the first polymeric organic binder;
(b) contacting the precursor material with a polymeric organic binder solution to form a solvated adsorbent mixture in a first solvent, wherein the polymeric organic binder solution comprises a second polymeric organic binder and the first solvent, wherein the solvated adsorbent mixture comprises the adsorbent material, the first polymeric organic binder, the second polymeric organic binder, and the first solvent, wherein the first polymeric organic binder and the second polymeric organic binder are adsorbed onto a surface of the adsorbent material and wherein the first solvent is distributed throughout the solvated adsorbent mixture;
(c) subjecting the solvated adsorbent mixture to a body forming process, wherein the process comprises:
(i) at least one process step selected from the group consisting of spreading, extrusion, cutting, milling, sieving, molding, granulation, pressing and tabletting; and
(ii) a solvent drying step comprising removing at least some of the first solvent from the solvated adsorbent mixture to form an initial adsorbent body; and
(d) solvent-drying to form the adsorbent body.

33. The process according to claim 32 wherein the process further comprises step (c1) occurring between steps (c) and (d), wherein step (c1) comprises contacting the initial adsorbent body with a second solvent in a solvent washing step to form a reduced-binder adsorbent body, wherein during step (c1) residual adsorbent material and/or adsorbent material precursors, a residual first solvent and at least 2% of the combined weight of the first and second polymeric organic binder is removed from the initial adsorbent body and is dissolved into the second solvent, wherein the reduced-binder adsorbent body comprises the adsorbent material, the first polymeric organic binder, the second polymeric organic binder, the second solvent, and the residual first solvent, wherein the first polymeric organic binder and the second polymeric organic binder are adsorbed onto the surface of the adsorbent material and wherein the second solvent is distributed throughout the reduced-binder adsorbent body.

34. The process according to claim 33 wherein the adsorbent material in step (a) is provided in a third solvent.

35. The process according to claim 32 wherein the adsorbent material is a MOF.

36. The process according to claim 33 wherein a solubility of the first polymeric organic binder and the second polymeric organic binder in the first solvent is higher than the solubility of the first polymeric organic binder and the second polymeric organic binder in the second solvent.

37. The process according to claim 32, wherein the first polymeric organic binder is different than the second polymeric organic binder.

38. The process according to claim 32, wherein the first polymeric organic binder is the same as the second polymeric organic binder.

39. The process according to claim 33, wherein between greater than 2% and less than 20% of a combined weight of the first and second polymeric organic binder is removed from the initial adsorbent body in step (c1).

40. The process according to claim 32, wherein a weight ratio of adsorbent material to the first and second polymeric organic binder present in the solvated adsorbent mixture is in a range of from 2:1 to 9:1 and wherein a ratio of the first binder to the second binder is between 1:4 to 4:1.

41. The process according to claim 32, wherein a weight ratio of adsorbent material to the first and second polymeric organic binder present in the adsorbent body is greater than 3:1

42. The process according to claim 32, wherein the adsorbent material is in particulate form having a mean particle size less than 900 nm.

43. The process according to claim 32, wherein the solvent-drying step in step (c) is a low temperature drying step, wherein the drying step is carried out at a temperature of less than 50 °C, for a period of time of longer than 5 hours, and at pressure of from 0.5 to 1.0 bar (50000 to 100000 Pa), and wherein the first solvent has a boiling point of 100 °C or less.

44. The process according to claim 32, wherein the adsorbent material is a metal-organic framework (MOF) body selected from the group consisting of HKUST-1, ZIF-8, MOF-808, ZU-301, UTSA-16, CALF-20, CALF-15, TIFSIX-3-Ni, NbOFFIVE-1, MOF-74/CPO-27, SIFSIX, UiO-66, UiO-67, UiO-68, NU-1000, PCN-222, Al or Zr Fumarate, Al Formate and any mixtures thereof.

45. The process according to claim 32, wherein the first polymeric organic binder and the second polymeric organic binder are each independently selected from polyvinyl alcohol (PVA), polyvinyl acetate, polyvinyl alcohol/acetate copolymers, polyimide, polyamide, polyvinyl pyrrolidone, polyacrylates include polyacrylic acid, polycarboxylates, polyethylene glycols, poly(1,4-phenylene-ether-ether-sulfone) (PFEES), poly(tetrahydrofuran) (PTHF), polylactic acid and derivatives thereof, a biopolymer-based material including polysaccharide gums, xantham gum, guar gum, alginate, chitosan, cellulose-based polymers, cellulose, cellulose acetate, hydroxypropyl methyl cellulose (HPMC), methyl cellulose, ethyl cellulose, hydroxyethyl cellulose, or hydroxypropyl methylcellulose phthalate (HPMCP), or any mixtures and combinations thereof.

46. The process according to claim 33, wherein the second solvent is selected from alcohols and glycols, and wherein the second solvent has a molecular weight of less than 600Da.

47. The process according to claim 32, wherein the adsorbent body further comprises a material selected from:
(a) nanoparticles of metals and metal salts;
(b) enzymes;
(c) magnetic materials;
(d) dyes and pigments;
(e) graphene and graphene oxide; and
(f) any combination thereof.

48. A composition comprising a plurality of adsorbent bodies made according to the process as defined in claim 32.

49. The process according to claim 32 further comprising storing in a gas storage vessel a composition comprising a plurality of the adsorbent bodies.

50. The process according to claim 49, wherein the gas storage vessel comprises:
a. insulation of the external walls;
b. means for heating and cooling the composition;
c. internal baffles;
d. means for retaining the composition in place;
e. means for retaining the composition in place such that the composition is more than about 10 cm from an external wall;
f. means for monitoring pressure and temperature; and/or
g. valves to control gas input and output flows.

51. The process of claim 49 further comprising using the gas storage vessel for the uptake, storage and/or release of a gas.

52. The process according to claim 51, wherein the gas comprises hydrogen, carbon dioxide, methane, krypton or mixtures thereof.

53. The process according to claim 51, wherein the process is part of a gas purification process.

54. The process according to claim 51, wherein the gas comprises hydrogen and the MOF comprises HKUST-1, ZIF-8, MOF-808, ZU-301, UiO-66 or mixtures thereof.

55. The process according to claim 54, wherein the composition comprises a bulk volumetric composition of MOF of from about 0.4 g/cm³ to about 1.1 g/cm³ and hydrogen of from about 0.025 g/cm³ to about 0.09 g/cm³ at 77 K and 10 atm (1013.25 kPa).

56. The process according to claim 51, wherein the gas comprises carbon dioxide and the MOF comprises UTSA-16, CALF-20, ZU-301, TIFSIX-3-Ni, NbOFFIVE-1, UiO-66-NH₂ or mixtures thereof.

57. The process according to claim 56, wherein the composition comprises a bulk volumetric composition of MOF of from about 0.4 g/cm³ to about 1.1 g/cm³ and carbon dioxide of from about 0.03 to about 0.14 g/cm³ at 293 K and 5 atm (506.625 kPa).

58. The process according to claim 51, wherein the gas comprises krypton and the MOF is MOF-74-Mg.

59. The process according to claim 58, wherein the composition comprises a bulk volumetric composition of MOF of from about 0.4 to 1.1 g/cm³ and krypton of from about 0.03 to 0.14 g/cm³ at 293 K and 5 atm (506.625 kPa).

60. The process according to claim 51, wherein the gas comprises methane and the MOF is HKUST-1.

61. The process according to claim 60, wherein the composition comprises a bulk volumetric composition of MOF of from about 0.4 to 1.1 g/cm³ and methane of from about 0.03 to 0.14 g/cm³ at 293 K and 5 atm (506.625 kPa).

62. The process of claim 49, wherein the adsorbent material comprises the metal-organic framework (MOF) and the adsorbent body comprises:
(a) at least 50 wt % metal-organic framework (MOF) particles; and
(b) from 2.0 wt % to 25 wt % organic polymeric binder, wherein the organic polymeric binder comprises the first polymeric organic binder and the second polymeric organic binder,
wherein the adsorbent body has:
(i) an envelope density of greater than 0.5 g/cm³;
(ii) a relative density of from greater than 0.4 to less than 1.2;
(iii) a BET area of greater than 10 m²/g;
(iv) a micro-porosity of greater than 40% of the total pore volume as measured by N₂ adsorption; and
(v) a macro-porosity of less than 15% as measured by mercury porosimetry.
